(19) United States
(12) Patent Application Publication
(10) Pub. No.: US 2025/0237502 A1
(43) Pub. Date: Jul. 24, 2025

(54) Estimating the Altitude of a Wireless Terminal Based on Changes in Barometric Pressure

(71) Applicant: Polaris Wireless, Inc., Santa Clara, CA (US)

(72) Inventor: Jian Zhu, Cupertino, CA (US)

(73) Assignee: Polaris Wireless, Inc., Santa Clara, CA (US)

(21) Appl. No.: 18/418,241

(22) Filed: Jan. 20, 2024

(51) Int. Cl. G01C 5/06

(52) U.S. Cl. CPC G01C 5/06

(57) ABSTRACT

A system for estimating the altitude of a cellular telephone or other wireless device based on a measurement of barometric pressure. The system cleverly uses cellular telephones at various locations to assist in generating an accurate estimate of a reference barometric pressure p₀. For example, the system has a cellular telephone near the location of interest make two measurements of barometric pressure near the time of interest. Thereafter, the system calculates the change in barometric pressure Δp during the time-interval Δt when the measurements were made. If the cellular telephone is stationary during the time-interval Δt, then the system reasonably conclude that the value of Δp is caused by changes in the atmosphere and not by the movement of the cellular telephone. In this case, the system can use Δp as a factor in generating the reference barometric pressure p₀; otherwise, it cannot.

### FIELD OF THE INVENTION

The present invention relates to telecommunications in general, and, more particularly, to methods for estimating the location of a wireless terminal (e.g., a cell phone, etc.).

### BACKGROUND OF THE INVENTION

It is well known in the prior art that the barometric pressure of the atmosphere decreases logarithmically with altitude, and, therefore, the altitude of an object (e.g., an airplane, a weather balloon, a cell phone in a building, etc.) can be estimated based on a measurement of the absolute barometric pressure of the atmosphere in the vicinity of the object to a reference barometric pressure at a known altitude (e.g., mean sea level, etc.).

### SUMMARY OF THE INVENTION

The altitude of an object can be estimated by comparing:
(i) a measurement of the absolute barometric pressure p₁ of the atmosphere in the vicinity of the object, to
(ii) a known or estimated reference barometric pressure p₀ at a known altitude.
   In order for the estimate of the altitude to be accurate:
(i) the estimate of p₀ must coincide closely with the latitude and longitude of the measurement of p₁.
(ii) the estimate of p₀ must coincide closely in time with the measurement of p₁, and
   To the extent that one or both do not coincide, the accuracy of the estimate suffers.

In practice, it is not easy to generate an accurate estimate of the reference barometric pressure p₀ that closely coincides with the latitude, longitude, and time of the measurement of p₁. First, it is not possible for there to be a barometer at each latitude and longitude and so the reference barometric pressure p₀ at the latitude and longitude of the object must be estimated from the measurements at nearby barometers. Second, the reference barometric pressure p₀ must often be estimated from measurements at different times than the measurement of p₁.

it is often not possible to have empirical pressure measurements that coincide closely in time the measurement of p₁

Some embodiments of the present invention endeavor to make better estimates of the reference barometric pressure p₀ without some of the costs and disadvantages for doing so in the prior art.

In accordance with the illustrative embodiments, a primary barometer at a known elevation z_{b} measures the absolute barometric pressure p₁ for a first moment-in-time t₁ of the atmosphere in its immediate vicinity. Sometime later, a first wireless terminal at an unknown elevation measures the absolute barometric pressure p₂ at a second moment-in-time t₂ of the atmosphere in its immediate vicinity. In order to estimate the elevation of the first wireless terminal, an estimate of the reference barometric pressure p₀ at the latitude and longitude of the first wireless terminal needs to be made.

The naïve approach in the prior art is simply to deem the measure of absolute barometric pressure p₁ at the primary barometer as the reference barometric pressure p₀. This is disadvantageous for two reasons. First it does not attempt to compensate for changes in barometric pressure during the interval from the first moment-in-time t₁ to the second moment-in-time t₂. Second, it does not attempt to compensate for the difference in pressure between the latitude and longitude of the primary barometer and the first wireless terminal. The illustrative embodiments of the present invention address these changes.

In accordance with some embodiments of the present invention, a change in barometric pressure Δp is determined for the interval from the first moment-in-time t₁ to the second moment-in-time t₂ by a second wireless terminal in the vicinity of the first wireless terminal. If the second wireless terminal is stationary during that interval, then it can be reasonably assumed that any measured change in the barometric pressure during the interval is caused by changes in the atmosphere and not by the movement of the second wireless terminal. In this case, the reference barometric pressure p₀ for the latitude and longitude of the first wireless terminal is estimated based on:
(i) the sum of p₁+Δp, and
(ii) the elevation z_{b} of the primary barometer
   according to:

$${p}_{0} = ( {p}_{1} + Δ p ) {e}^{( \frac{{z}_{b}}{H} )} \qquad ( Eq . 1 b )$$

wherein H is the scale height of the atmosphere, which equals approximately 7000 meters.

This approach is advantageous because it takes full advantage of the good luck of their being another wireless terminal being in the vicinity that can assist in improving the estimate of the reference barometric pressure p₀. If the second wireless terminal is not stationary during the interval from the first moment-in-time t₁ to the second moment-in-time t₂, then it is not reasonable to assume that any measured changes in the barometric pressure are attributable to changes in the atmosphere and Equation 1b is inapplicable.

### BRIEF DESCRIPTION OF THE DRAWINGS

FIG. 1 depicts a map of geographic region 101, which contains the elements of the illustrative embodiments that estimate the altitude of a wireless terminal based on measurements of barometric pressure.

FIG. 2 is a block diagram of the salient components of primary barometer 111 in accordance with the illustrative embodiments of the present invention.

FIG. 3 is a block diagram of the salient components of secondary barometer 112-i in accordance with the illustrative embodiments of the present invention.

FIG. 4 is a block diagram of the salient components of wireless terminal 113-j in accordance with the illustrative embodiments of the present invention.

FIG. 5 is a block diagram of the salient components of altitude server 131 in accordance with the illustrative embodiments of the present invention.

FIG. 6 is a block diagram of the salient components of location-based-application server 141 in accordance with the illustrative embodiments of the present invention.

FIG. 7 depicts a flowchart of the operation of the first illustrative embodiment of the present invention.

FIG. 8 depicts the relationship of a first time-interval Δt to a time-interval from a first moment-in-time t₁ to a second moment-in-time t₂.

FIG. 9 depicts the relationship of a second first time-interval Δt to a time-interval from a first moment-in-time t₁ to a second moment-in-time t₂.

FIG. 10 depicts the relationship of a first pair of time-intervals Δt₁ and Δt₂ to a time-interval from a first moment-in-time t₁ to a second moment-in-time t₂.

FIG. 11 depicts the relationship of a second pair of time-intervals Δt₁ and Δt₂ to a time-interval from a first moment-in-time t₁ to a second moment-in-time t₂.

FIG. 12 depicts the relationship of a third pair of time-intervals Δt₁ and Δt₂ to a time-interval from a first moment-in-time t₁ to a second moment-in-time t₂.

FIG. 13 depicts a flowchart of the operation of the task 704—generates an estimate of the altitude of wireless terminal 113-1, s_{w}, in building stories above local ground level.

FIG. 14 depicts a flowchart of the operation of the second illustrative embodiment of the present invention.

FIG. 15 depicts a flowchart of the operation of the third illustrative embodiment of the present invention.

FIG. 16 depicts a flowchart of the operation of the fourth illustrative embodiment of the present invention.

FIG. 17 depicts a flowchart of the operation of the fifth illustrative embodiment of the present invention.

FIG. 18 depicts a flowchart of the operation of the sixth illustrative embodiment of the present invention.

### DEFINITIONS

Altitude—For the purposes of this disclosure, the term “altitude” is defined as a distance along a radius from Earth's center that is uniquely identifiable by a scalar relative to a datum (e.g., meters above mean sea level, etc.). The term elevation is typically used describe the altitude of an object with respect to local ground level.

Based on—For the purposes of this disclosure, the phrase “based on” is defined as “being dependent on” in contrast to “being independent of”. The value of Y is dependent on the value of X when the value of Y is different for two or more values of X. The value of Y is independent of the value of X when the value of Y is the same for all values of X. Being “based on” includes both functions and relations.

Elevation—For the purposes of this disclosure, the term “elevation” is defined as a distance along a radius from Earth's center that is uniquely identifiable by a scalar relative to a datum (e.g., meters above mean sea level, etc.). The term elevation is typically used describe the altitude of local ground level at a latitude and longitude.

Generate—For the purposes of this disclosure, the infinitive “to generate” and its inflected forms (e.g., “generating”, “generation”, etc.) should be given the ordinary and customary meaning that the terms would have to a person of ordinary skill in the art at the time of the invention.

Processor—For the purposes of this disclosure, a “processor” is defined as hardware or hardware and software that performs mathematical and/or logical operations.

Receive—For the purposes of this disclosure, the infinitive “to receive” and its inflected forms (e.g., “receiving”, “received”, etc.) should be given the ordinary and customary meaning that the terms would have to a person of ordinary skill in the art at the time of the invention.

Transmit—For the purposes of this disclosure, the infinitive “to transmit” and its inflected forms (e.g., “transmitting”, “transmitted”, etc.) should be given the ordinary and customary meaning that the terms would have to a person of ordinary skill in the art at the time of the invention.

Wireless Terminal—For the purposes of this disclosure, the term “wireless terminal” is defined as a tangible device that is capable of telecommunications without a wire or tangible transmission medium. A wireless terminal can be mobile or immobile. A wireless terminal can transmit or receive or transmit and receive.

### DETAILED DESCRIPTION

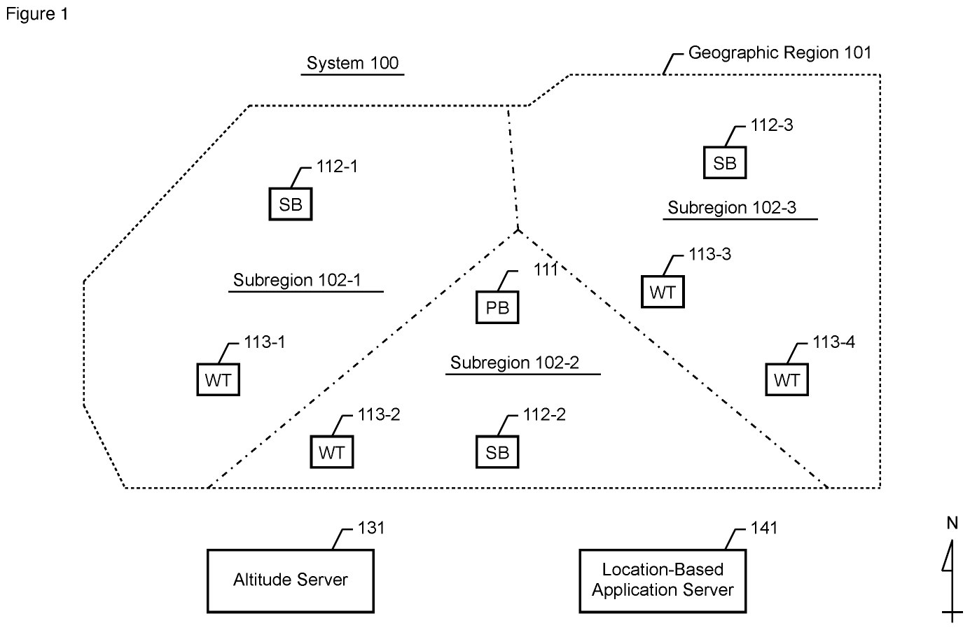

The illustrative embodiments of the present invention involve system 100. System 100 comprises a number of geographically-distributed components that communicate with each other in well-known fashion. FIG. 1 depicts a map of geographic region 101 and the relative location of the components in system 100.

In accordance with the illustrative embodiments, geographic region 101 has an area of 2500 square kilometers (˜ 965 square miles). It will be clear to those skilled in the art, after reading this disclosure, how to make and use alternative embodiments of the present invention in which the geographic region has any size (e.g., 100 square kilometers, 1000 square kilometers, 10,000 square kilometers, 100,000 square kilometers, etc.).

In accordance with the illustrative embodiment, the boundary of geographic region 101 is a polygon, and the boundary is unrelated to any geographic, political, or terrestrial features. It will be clear to those skilled in the art, however, after reading this disclosure, how to make and use alternative embodiments of the present invention in which the boundary of the geographic region is any closed loop. Furthermore, it will be clear to those skilled in the art, after reading this disclosure, how to make and use alternative embodiments of the present invention in which some or all of the boundary is related to one or more geographic, political, or terrestrial features.

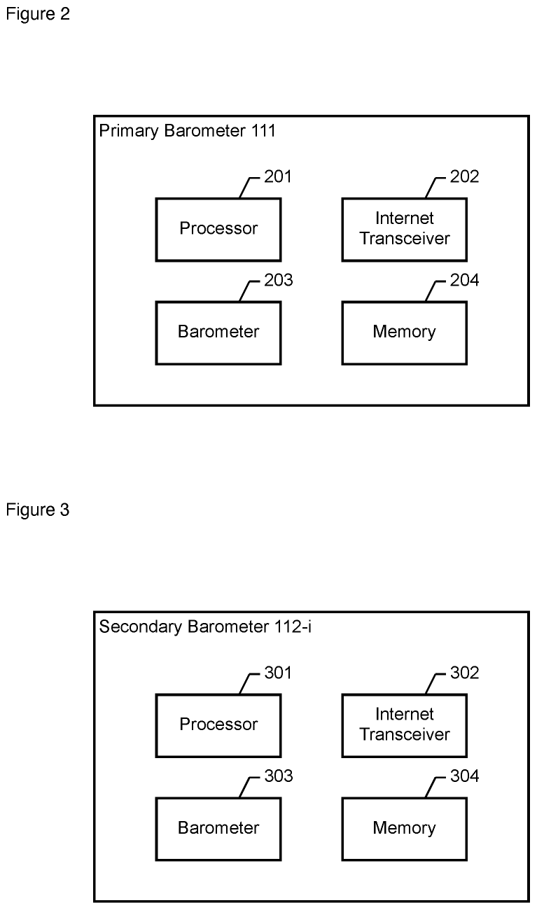

Geographic region 101 is divided into three subregions: subregion 102-1, subregion 102-2, and subregion 102-3, as shown in FIG. 2. It will be clear to those skilled in the art, after reading this disclosure, how to make and use alternative embodiments of the present invention that comprise any number of subregions, and it will also be clear to those skilled in the art, after reading this disclosure, how to make and use alternative embodiments of the present invention that do not have any subregions.

System 101 comprises:
(i) primary barometer 111,
(ii) secondary barometer 112-1, secondary barometer 112-2, and secondary barometer 112-3,
(iii) wireless terminal 113-1, wireless terminal 113-2, wireless terminal 113-3, and wireless terminal 113-4,
(iv) altitude server 131, and
(v) location-based-application server 141.

Primary Barometer 111—The illustrative embodiment comprises one primary barometer-primary barometer 111—which sporadically:
(i) measures the absolute barometric pressure p of the atmospheric in its vicinity, and
(ii) publishes (i.e., transmits) the resulting measurements, via the Internet, to the public at large, altitude server 131, wireless terminal 113-1, wireless terminal 113-2, wireless terminal 113-3, and wireless terminal 113-4.
   Primary barometer 111 is a combination of hardware and software that is connected to the Internet (not shown in FIG. 1) and is capable of performing the functionality described herein and in the accompanying figures. The details of primary barometer 111 are described in detail below and in the accompanying figures.

The illustrative embodiment comprises one primary barometer, but it will be clear to those skilled in the art, after reading this disclosure, how to make and use alternative embodiments of the present invention that comprise any number of primary barometers (e.g., 2, 3, 4, 5, 8, 10, 20, 100, 500, 1000, etc.).

In accordance with the illustrative embodiment, primary barometer 111 is owned and operated by the United States Federal Aviation Administration. It will be clear to those skilled in the art, after reading this disclosure, how to make and use alternative embodiments of the present invention in which the primary barometer is not owned or operated by the United States Federal Aviation Administration.

In accordance with the illustrative embodiment, primary barometer 111 is stationary. It will be clear to those skilled in the art, after reading this disclosure, how to make and use alternative embodiments of the present invention in which the primary barometer is mobile.

In accordance with the illustrative embodiment, a very accurate estimate of the latitude and longitude of primary barometer 111 is known by the public at large, altitude server 131, wireless terminal 113-1, wireless terminal 113-2, wireless terminal 113-3, and wireless terminal 113-4.

In accordance with the illustrative embodiment, a very accurate estimate of the altitude of primary barometer 111, z_{b}, is known by the public at large, altitude server 131, wireless terminal 113-1, wireless terminal 113-2, wireless terminal 113-3, and wireless terminal 113-4.

In accordance with the illustrative embodiment, each measurement of the absolute barometric pressure p by primary barometer 111 is made at a moment-in-time t (e.g., 13:10:15 UTC, Apr. 6, 2025, etc.). When primary barometer 111 publishes a measurement p, a description of the moment-in-time t for which the measurement applies accompanies the measurement as metadata.

In accordance with the illustrative embodiment, primary barometer 111 does not publish a measurement of the absolute barometric pressure p immediately after the measurement is made. In contrast, primary barometer 111 delays publishing the measurement in order to ensure that the measurement is accurate (e.g., temperature compensated, etc.). In accordance with the illustrative embodiment, the delay varies and is typically in the range of ten to twenty minutes. In other words, a measurement of absolute barometric pressure p at primary barometer 111 is typically ten to twenty minutes old when it is published.

It will be clear to those skilled in the art how to make and use primary barometer 111.

Secondary Barometer 112-i, wherein i∈{1, 2, 3}—The illustrative embodiment comprises three secondary barometers-secondary barometer 112-1, secondary barometer 112-2, and secondary barometer 112-3—each of which operates independently and periodically:
(i) measures the absolute barometric pressure p of the atmospheric in its vicinity, and
(ii) publishes (i.e., transmits) the resulting measurements, via the Internet, to the public at large, altitude server 131, wireless terminal 113-1, wireless terminal 113-2, wireless terminal 113-3, and wireless terminal 113-4.
   Secondary barometer 112-i is a combination of hardware and software that is connected to the Internet (not shown in FIG. 1) and is capable of performing the functionality described herein and in the accompanying figures. The details of secondary barometer 112-i are described in detail below and in the accompanying figures.

The illustrative embodiment comprises three secondary barometers, but it will be clear to those skilled in the art, after reading this disclosure, how to make and use alternative embodiments of the present invention that comprise any number of secondary barometers (e.g., 1, 2, 3, 4, 5, 6, 8, 10, 20, 50, 100, 250, etc.). Furthermore, it will be clear those skilled in the art, after reading this disclosure, how to make and use alternative embodiments of the present invent that do not comprise any secondary barometers.

In accordance with the illustrative embodiment, each of secondary barometer 112-1, secondary barometer 112-2, and secondary barometer 112-3 is at a different location.

In accordance with the illustrative embodiment, none of secondary barometer 112-1, secondary barometer 112-2, and secondary barometer 112-3 is co-located with primary barometer 111. It will be clear to those skilled in the art, however, after reading this disclosure, how to make and use alternative embodiments of the present invention in which one or more secondary barometers are co-located with a primary barometer.

In accordance with the illustrative embodiment, the measurements of change in barometric pressure Δp by secondary barometer 112-i are treated as representative of the changes in barometric pressure throughout subregion 102-i.

In accordance with the illustrative embodiment, subregion 102-1 is defined to be that portion of geographic region 101 that is closer to secondary barometer 112-1 than either secondary barometer 112-2 or 112-3. Similarly, subregion 102-2 is defined to be that portion of geographic region 101 that is closer to secondary barometer 112-2 than either secondary barometer 112-1 or 112-3, and lastly, subregion 102-3 is defined to be that portion of geographic region 101 that is closer to secondary barometer 112-3 than either secondary barometer 112-1 or 112-2. It will be clear to those skilled in the art, after reading this disclosure, how to make and use alternative embodiments of the present invention in which the geographic scope of one or more subregions is defined using different criteria.

In accordance with the illustrative embodiment, secondary barometer 112-i is privately owned and operated, but it will be clear to those skilled in the art, after reading this disclosure, how to make and use alternative embodiments in which one or more secondary barometers are publicly owned and/or operated. In accordance with the illustrative embodiment, secondary barometer 112-i is part of the Purple Air® network, https://www2.purpleair.com, but it will be clear to those skilled in the art, after reading this disclosure, how to make and use alternative embodiments of the present invention in which one or more of the secondary barometers are part of another network (e.g., Weather Underground®, https://www.wunderground.com, etc.) or no network at all.

In accordance with the illustrative embodiment, secondary barometer 112-i is stationary. It will be clear to those skilled in the art, after reading this disclosure, how to make and use alternative embodiments of the present invention in which one or more secondary barometers is mobile.

In accordance with the illustrative embodiment, an estimate of the latitude and longitude of secondary barometer 112-i is known by the public at large, altitude server 131, wireless terminal 113-1, wireless terminal 113-2, wireless terminal 113-3, and wireless terminal 113-4.

In accordance with the illustrative embodiment, an estimate of the altitude of secondary barometer 112-i is known by the public at large, altitude server 131, wireless terminal 113-1, wireless terminal 113-2, wireless terminal 113-3, and wireless terminal 113-4.

In accordance with the illustrative embodiment, each measurement of the absolute barometric pressure p by secondary barometer 112-i is made at a moment-in-time t. When secondary barometer 112-i publishes a measurement p, a description of the moment-in-time t for which the measurement applies accompanies the measurement as metadata.

In accordance with the illustrative embodiment, each measurement of the absolute barometric pressure p by secondary barometer 112-i is published within a few seconds after the measurement is made. It will be clear to those skilled in the art, after reading this disclosure, how to make and use alternative embodiments of the present invention there is a longer delay.

In accordance with the illustrative embodiment, altitude server 131 and wireless terminal 113-j can compute the change in barometric pressure at secondary barometer 112-i during a time-interval Δt by computing the difference between the later measurement p₂ and the earlier measurement p₁. It will be clear to those skilled in the art, after reading this disclosure, how to make and use alternative embodiments of the present invention in which a secondary barometer explicitly publishes a change in barometric pressure for a specific time-interval Δt (e.g., as a single scalar value for a beginning moment-in-time t₁ and an ending moment-in-time t₂, etc.). In these cases, the secondary barometer can either publish, via the Internet, the values periodically (e.g., every 10 seconds, etc.) or sporadically sua sponte, or in response to a query from another entity (e.g., altitude server 131, wireless terminal 113-j, etc.).

It will be clear to those skilled in the art how to make and use secondary barometer 112-i.

Wireless Terminal 113-j, wherein j∈{1,2, 3,4}—The illustrative embodiment comprises four wireless terminals-wireless terminal 113-1, wireless terminal 113-2, wireless terminal 113-3, and wireless terminal 113-4—each of which operates independently and periodically:
(i) measures the absolute barometric pressure p of the atmospheric in its vicinity, and
(ii) transmits the resulting measurements, via the Internet, to altitude server 131.
   In accordance with the illustrative embodiment, wireless terminal 113-j is a combination of hardware and software that is connected to the Internet (not shown in FIG. 1) and is capable of performing the functionality described herein and in the accompanying figures. The details of wireless terminal 113-j are described below and in the accompanying figure.

In accordance with the illustrative embodiment, wireless terminal 113-j comprises application software, sometimes colloquially called “an app,” that performs all of the non-system-software functionality described herein and in the accompanying figures. It will be clear to those skilled in the art, after reading this disclosure, how to create and install this software on wireless terminal 113-j.

The illustrative embodiment comprises four wireless terminals. It will be clear to those skilled in the art, after reading this disclosure, how to make and use alternative embodiments of the present invention that comprise any number of wireless terminals (e.g., 1, 2, 3, 4, 5, 10, 100, 1000, 10,000, 100,000, 1,000,000, etc.).

In accordance with the illustrative embodiment, wireless terminals 113-1, 113-2, 113-3, and 113-4 are mobile and can be at any latitude and longitude and any altitude in geographic region 101 at any time.

In accordance with the illustrative embodiment, wireless terminals 113-1, 113-2, 113-3, and 113-4 are at different locations from each other. It will be clear to those skilled in the art, after reading this disclosure, how to make and use alternative embodiments of the present invention in which two or more wireless terminals are co-located.

In accordance with the illustrative embodiment, none of wireless terminals 113-1, 113-2, 113-3, and 113-4 are co-located with primary barometer 112. It will be clear to those skilled in the art, after reading this disclosure, how to make and use alternative embodiments of the present invention in which one or more wireless terminals are co-located with primary barometer 112.

In accordance with the illustrative embodiment, none of wireless terminals 113-1, 113-2, 113-3, and 113-4 are co-located with a secondary barometer. It will be clear to those skilled in the art, after reading this disclosure, how to make and use alternative embodiments of the present invention in which one or more wireless terminals are co-located with a secondary barometer.

In accordance with the illustrative embodiment, wireless terminal 113-j is privately owned and operated, but it will be clear to those skilled in the art, after reading this disclosure, how to make and use alternative embodiments in which one or more wireless terminals are publicly owned and/or operated.

In accordance with the illustrative embodiment, an estimate of the latitude and longitude of wireless terminal 113-j is known by altitude server 131 and wireless terminal 113-k, wherein k∈{1, 2, 3, 4} and k≠j.

In accordance with the illustrative embodiment, each measurement of the absolute barometric pressure p by wireless terminal 113-j is made at a moment-in-time t. When wireless terminal 113-j publishes a measurement, a description of the moment-in-time t for which the measurement applies accompanies the measurement as metadata.

In accordance with the illustrative embodiment, each measurement of the absolute barometric pressure p by wireless terminal 113-j is published within a few seconds after the measurement is made. It will be clear to those skilled in the art, after reading this disclosure, how to make and use alternative embodiments of the present invention there is a longer delay.

In accordance with the illustrative embodiment, altitude server 131 can compute the change in barometric pressure Δp (Δp=p₂−p₁) at wireless terminal 113-j during any time-interval Δt (Δt=t₂−t₁) by computing the difference in the later measurement p₂ (which is made at moment-in-time t₂) and the earlier measurement p₁ (which is made at moment-in-time t₁).

In accordance with the illustrative embodiment, wireless terminal 113-k, can obtain the change in barometric pressure at wireless terminal 113-j during any time-interval by transmitting a request to wireless terminal 113-j for an indication of the change in barometric pressure at wireless terminal 113-j during a specific time-interval. In response to such a request, wireless terminal 113-j transmits back to wireless terminal 113-k:
(i) an indication of the change in barometric pressure at wireless terminal 113-j during the time-interval, and
(ii) an indication of whether or not wireless terminal 113-j during the time-interval was stationary during the time-interval.

In accordance with the illustrative embodiment, the indication of the change in barometric pressure at wireless terminal 113-j during the time-interval provided explicitly (e.g., as a single scalar value for the change in barometric pressure plus a metadata indication of the moment-in-time at the beginning of the time-interval and the moment-in-time at the end of the time-interval, etc.). In some alternative embodiments of the present invention, the indication of the change in barometric pressure at wireless terminal 113-j during the time-interval provided implicitly as:
(i) a first measurement of absolute barometric pressure p₁ for the moment-in-time at the beginning of the time-interval Δt; and
(ii) a second measurement of absolute barometric pressure p₂ for the moment-in-time at the end of the time-interval Δt.

In these cases, the change in barometric pressure is determined simply by calculating the difference between p₂ and p₁.

In accordance with the illustrative embodiment, the indication of whether or not wireless terminal 113-j during the time-interval was stationary during the time-interval is a flag. It will be clear to those skilled in the art, after reading this disclosure, how to make and use alternative embodiments of the present invention in which the indication of whether or not wireless terminal 113-j during the time-interval was stationary during the time-interval is not a flag.

It will be clear to those skilled in the art how to make and use wireless terminal 113-j.

Altitude Server 131—In accordance with the illustrative embodiment, altitude server 131 is a combination of hardware and software that is connected to the Internet (not shown in FIG. 1) and is capable of performing the functionality described herein and in the accompanying figures. The details of altitude server 131 are described below and in the accompanying figure. For example, and without limitation, altitude server 131 comprises: a topological map of geographic region 101 that correlates latitude and longitude to local ground altitude in meters above mean sea level. Furthermore, altitude server 131 is capable of:
(i) receiving measurements of absolute barometric pressure- and associated metadata—from primary barometer 111, secondary barometers 112-1, 112-2, and 112-3, and wireless terminals 113-1, 113-2, 113-3, and 113-4, and
(ii) receiving (or calculating) measurement of changes in barometric pressure- and associated metadata—from secondary barometers 112-1, 112-2, and 112-3, and wireless terminals 113-1, 113-2, 113-3, and 113-4, and
(iii) generating estimates of the altitude of wireless terminals 113-1, 113-2, 113-3, and 113-4 as described below and in the accompanying figures, and
(iv) transmitting the estimates of the altitude to location-based-application server 141 and each of wireless terminals 113-1, 113-2, 113-3, and 113-4.
   It will be clear to those skilled in the art, after reading this disclosure, how to make and use altitude server 131.

Location-Based-Application Server 141—In accordance with the illustrative embodiment, location-based-application server 141 is a combination of hardware and software that is connected to the Internet (not shown in FIG. 1) and is capable of performing the functionality described herein and in the accompanying figures. The details of location-based-application server 141 are described below and in the accompanying figure. For example, and without limitation, location-based-application server 141 is capable of receiving an estimate of the latitude and longitude and estimate of altitude of each of wireless terminals 113-1, 113-2, 113-3, and 113-4 and of dispatching emergency first responders (e.g., police, fire, rescue, etc.) to that location. It will be clear to those skilled in the art, after reading this disclosure, how to make and use location-based-application server 141.

FIG. 2 is a block diagram of the salient components of primary barometer 111 in accordance with the illustrative embodiments of the present invention. Primary barometer 111 comprises: processor 201, Internet transceiver 202, barometer 203, and memory 204.

Processor 201 is a general-purpose processor, in well-known fashion, that performs the functionality described herein and in the accompanying figures. It will be clear to those skilled in the art how to make and use processor 201.

Internet transceiver 202 is a combination of hardware and software, in well-known fashion, that enables primary barometer 111 to receive and transmit data as described herein and in the accompanying figures. It will be clear to those skilled in the art how to make and use Internet transceiver 202.

Barometer 203 is hardware, in well-known fashion, that measures the absolute barometric pressure of the ambient atmosphere in its vicinity. It will be clear to those skilled in the art how to make and use barometer 203.

Memory 204 is a general-purpose non-volatile read-write memory, in well-known fashion, that contains system software and application software for processor 201 and data pertaining to barometric pressure measurements. It will be clear to those skilled in the art how to make and use memory 204.

It will be clear to those skilled in the art how to make and use primary barometer 111.

FIG. 3 is a block diagram of the salient components of secondary barometer 112-i in accordance with the illustrative embodiments of the present invention.

In accordance with the illustrative embodiment, secondary barometers 112-1, 112-2, and 112-3 are identical, but it will be clear to those skilled in the art, after reading this disclosure, how to make and use alternative embodiments of the present invention in which one or more of the secondary barometers are different.

Secondary barometer 112-i comprises: processor 301, Internet transceiver 302, barometer 303, and memory 304.

Processor 301 is a general-purpose processor, in well-known fashion, that performs the functionality described herein and in the accompanying figures. It will be clear to those skilled in the art how to make and use processor 301.

Internet transceiver 302 is a combination of hardware and software, in well-known fashion, that enables secondary barometer 112-i to receive and transmit data as described herein and in the accompanying figures. It will be clear to those skilled in the art how to make and use Internet transceiver 302.

Barometer 303 continually measures the absolute barometric pressure of the ambient atmosphere in its vicinity at successive moments-in-time. It will be clear to those skilled in the art how to make and use barometer 303.

Memory 304 is a general-purpose non-volatile read-write memory, in well-known fashion, that contains system software and application software for processor 301 and data pertaining to barometric pressure measurements. It will be clear to those skilled in the art how to make and use memory 304.

It will be clear to those skilled in the art how to make and use secondary barometer 112-i.

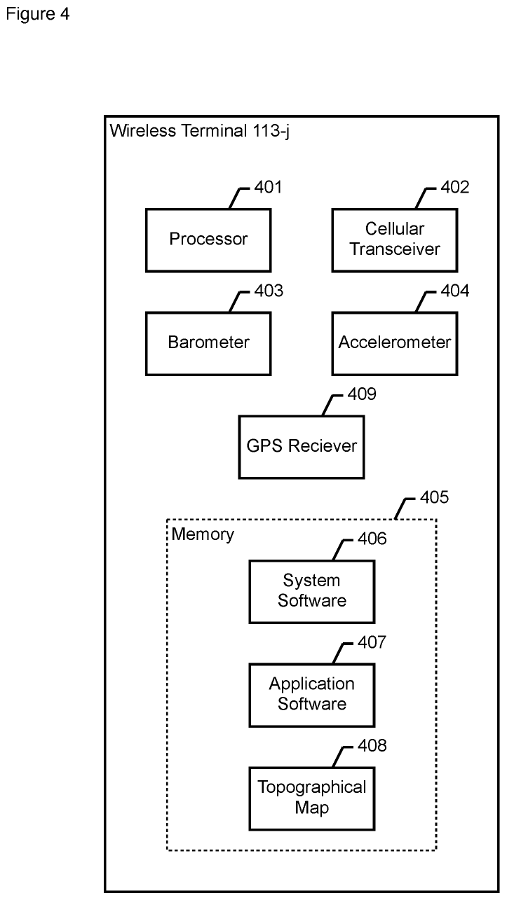

FIG. 4 is a block diagram of the salient components of wireless terminal 113-j in accordance with the illustrative embodiments of the present invention. Wireless terminal 113-j comprises: processor 401, cellular transceiver 402, barometer 403, accelerometer 404, memory 405, system software 406, application software 407, and topographical map 408.

Processor 401 is a general-purpose processor, in well-known fashion, that performs the functionality described herein and in the accompanying figures. It will be clear to those skilled in the art how to make and use processor 401. For example, and without limitation, processor 401 executes system software 406 and application software 407 in memory 405 and has access to topographical map 408, also in memory 405. It will be clear to those skilled in the art how to make and use processor 401.

Cellular transceiver 402 is a general-purpose radio, in well-known fashion, that enables wireless terminal 113-j to transmit and receive via radio and the Internet as described herein and in the accompanying figures. It will be clear to those skilled in the art how to make and use cellular transceiver 402.

Barometer 303 continually measures the absolute barometric pressure of the ambient atmosphere in its vicinity at successive moments-in-time. It will be clear to those skilled in the art how to make and use barometer 303.

Accelerometer 404 is a general-purpose accelerometer, in well-known fashion, that assists wireless terminal 113-j in determining whether or not wireless terminal 113-j is moving or stationary over a given time-interval. It will be clear to those skilled in the art how to make and use accelerometer 404.

Memory 405 is a general-purpose non-volatile read-wire memory, in well-known fashion, that contains: system software 406, application software 407, and topological map 408. It will be clear to those skilled in the art how to make and use memory 405.

System software 406 is the code that instructs processor 401 how to perform functions that are not application specific. It will be clear to those skilled in the art how to make and use system software 406.

Application software 407 is the code that instructs processor 401 to perform all of the functionality described herein and in the accompanying figures. It will be clear to those skilled in the art, after reading this disclosure, how to make and use application software 407.

Topological map 408 is a database that provides an estimate of the location ground level in meters above mean sea level for every latitude and longitude in geographic region 101. It will be clear to those skilled in the art how to make topological map 408 and use it as described herein and in the accompanying figures.

GPS receiver 409 is a satellite-positioning system receiver, in well-known fashion, that is capable of estimating the latitude and longitude of wireless terminal 113-j. It will be clear to those skilled in the art how to make and use GPS receiver 409.

It will be clear to those skilled in the art, after reading this disclosure, how to make and use wireless terminal 113-j.

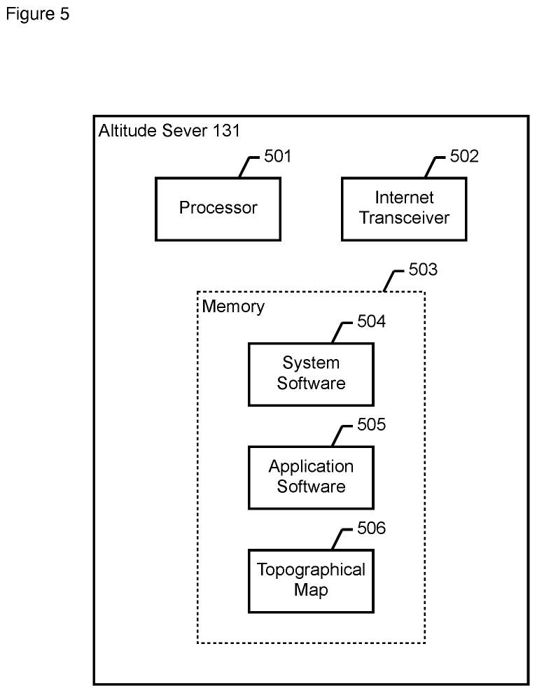

FIG. 5 is a block diagram of the salient components of altitude server 131 in accordance with the illustrative embodiments of the present invention. Altitude server 131 comprises: processor 501, Internet transceiver 502, memory 503, system software 504, application software 505, and topological map 506.

Processor 501 is a general-purpose processor, in well-known fashion, that performs the functionality described herein and in the accompanying figures. It will be clear to those skilled in the art how to make and use processor 501. For example, and without limitation, processor 401 executes system software 506 and application software 507 in memory 505 and has access to topographical map 508, also in memory 505. It will be clear to those skilled in the art how to make and use processor 501.

Internet transceiver 502 is a combination of hardware and software, in well-known fashion, that enables altitude server 131 to receive and transmit data as described herein and in the accompanying figures. It will be clear to those skilled in the art how to make and use Internet transceiver 502.

Memory 503 is a general-purpose non-volatile read-wire memory, in well-known fashion, that contains: system software 504, application software 505, and topological map 506. It will be clear to those skilled in the art how to make and use memory 503.

System software 504 is the code that instructs processor 501 how to perform functions that are not application specific. It will be clear to those skilled in the art how to make and use system software 504.

Application software 505 is the code that instructs processor 501 to perform all of the functionality described herein and in the accompanying figures. It will be clear to those skilled in the art, after reading this disclosure, how to make and use application software 505.

Topological map 506 is a database that provides an estimate of the location ground level in meters above mean sea level for every latitude and longitude in geographic region 101. Topological map 408 in wireless terminal 113-j and topological map 506 in altitude server 131 are identical. It will be clear to those skilled in the art how to make topological map 506 and use it as described herein and in the accompanying figures.

It will be clear to those skilled in the art, after reading this disclosure, how to make and use altitude server 131.

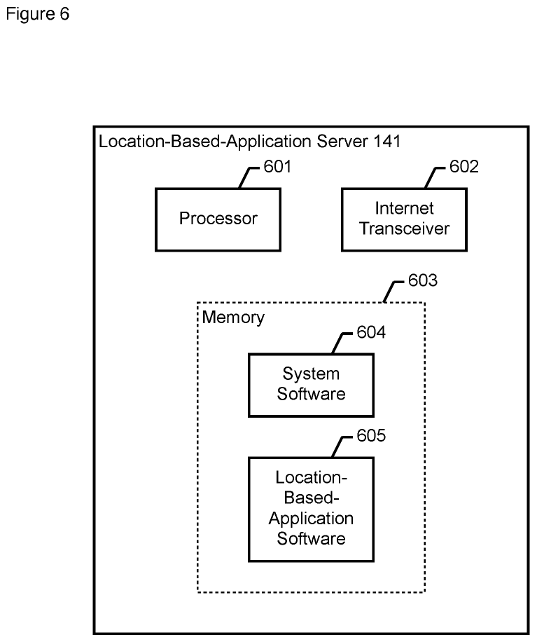

FIG. 6 is a block diagram of the salient components of location-based-application server 141 in accordance with the illustrative embodiments of the present invention. Location-based-application server 141 comprises: processor 601, Internet transceiver 602, and memory 603.

Processor 601 is a general-purpose processor, in well-known fashion, that performs the functionality described herein and in the accompanying figures. It will be clear to those skilled in the art how to make and use processor 601.

Internet transceiver 602 is a combination of hardware and software, in well-known fashion, that enables location-based-application server 141 to receive and transmit data as described herein and in the accompanying figures. It will be clear to those skilled in the art how to make and use Internet transceiver 802.

Memory 603 is a general-purpose non-volatile read-wire memory, in well-known fashion, that contains: system software 604 and location-based application software 605. It will be clear to those skilled in the art how to make and use memory 603.

System software 604 is the code that instructs processor 601 how to perform functions that are not application specific. It will be clear to those skilled in the art how to make and use system software 606.

Location-based application software 605 is the code that instructs processor 601 to perform all of the functionality that is dependent on the altitude of wireless terminal 113-j (e.g., dispatching emergency first responders, etc.) to the latitude and longitude and altitude of wireless terminal 113-j. It will be clear to those skilled in the art how to make and use location-based application 605.

It will be clear to those skilled in the art how to make and use location-based-application server 141.

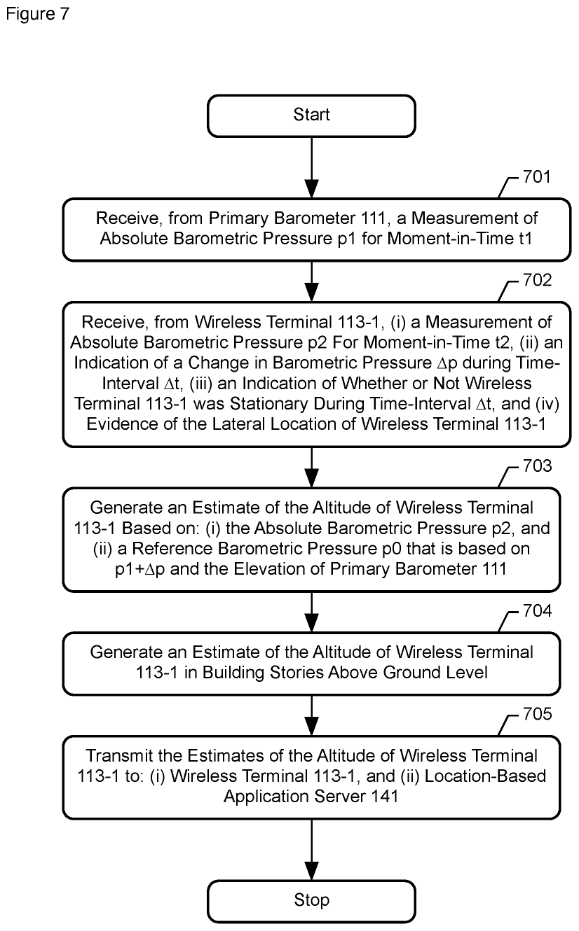

FIG. 7 depicts a flowchart of the operation of the first illustrative embodiment of the present invention.

At task 701, primary barometer 111 transmits and altitude server 131 receives a first measurement of absolute barometric pressure p₁ for moment-in-time t₁, wherein the first measurement of absolute barometric pressure p₁ is measured by barometer 203 in primary barometer 111. It will be clear to those skilled in the art how to make and use embodiments of the present invention that perform task 701.

At task 702, wireless terminal 113-1 transmits and altitude server 131 receives:
(i) a second measurement of absolute barometric pressure p₂ at a second moment-in-time t₂, wherein the second measurement of absolute barometric pressure p₂ is measured by barometer 403 in wireless terminal 113-1, and
(ii) an indication of a change in barometric pressure Δp during a time-interval Δt, wherein the change in barometric pressure Δp is measured by barometer 403 in wireless terminal 113-1, and
(iii) an indication of whether or not wireless terminal 113-1 was stationary during the time-interval Δt, and
(iv) evidence of the latitude and longitude of wireless terminal 113-1 at the second moment-in-time t₂.

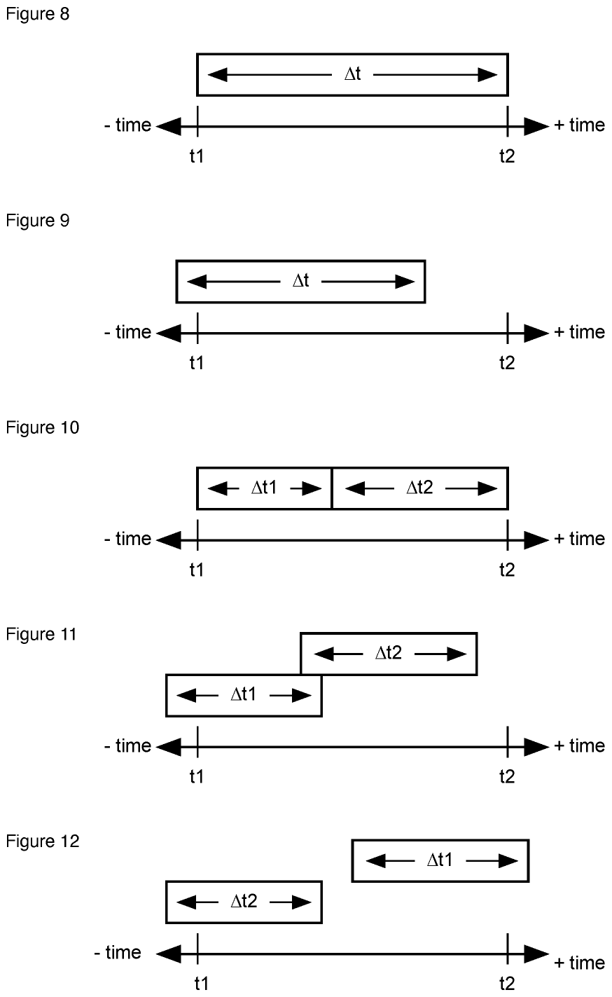

In accordance with the first the illustrative embodiment, the first moment-in-time t₁ is before the second moment-in-time t₂. In accordance with the first illustrative embodiment, the time-interval Δt is contemporaneous with the time-interval from the first moment-in-time t₁ to the second moment-in-time t₂, as shown in FIG. 8. In contrast, it will be clear to those skilled in the art, however, after reading this disclosure, how to make and use alternative embodiments of the present invention in which:
(i) the time-interval Δt is not contemporaneous with the time-interval from the first moment-in-time t₁ to the second moment-in-time t₂, and
(ii) the majority of the time-interval Δt overlaps the time-interval from the first moment-in-time t₁ to the second moment-in-time t₂, and
(iii) the majority of the time-interval from the first moment-in-time t₁ to the second moment-in-time t₂ overlaps the time-interval Δt,
   as shown, for example, in FIG. 9.

In accordance with the first illustrative embodiment, wireless terminal 113-1 estimates whether it was stationary or not during the time-interval Δt based, at least in part, measurements of accelerometer 404 during the time-interval Δt. It will be clear to those skilled in the art, after reading this disclosure, how to make and use alternative embodiments of the present invention in which a wireless terminal estimates whether it is stationary or not during the time-interval Δt based on other sensors and/or criteria.

In accordance with the first illustrative embodiment, the evidence of the latitude and longitude of wireless terminal 113-1 at moment-of-time t₂ is the latitude and longitude of wireless terminal 113-1. It will be clear to those skilled in the art, after reading this disclosure, how to make and use alternative embodiments of the present invention in which the evidence has another form (e.g., empirical data from which altitude server 131 can infer the latitude and longitude, etc.). In any case, it will be clear to those skilled in the art how to provide evidence of the latitude and longitude of wireless terminal 113-1.

At task 703, altitude server 131:
(1) generates an estimate of what the reference barometric pressure p₀ would be at mean sea level at the latitude and longitude of wireless terminal 113-1, and
(2) uses that reference barometric pressure p₀ to generate an estimate of the altitude of wireless terminal 113-1 z_{w} at moment-in-time t₂.

When the indication of whether or not wireless terminal 113-1 was stationary during the time-interval Δt indicates that wireless terminal 113-1 was not stationary, then altitude server 131 generates the estimate of p₀ according to:

$${p}_{0} = {p}_{1} {e}^{( \frac{{z}_{b}}{H} )} \qquad ( Eq . 1 a )$$

wherein:
   z_{b} is the estimate of the altitude of primary barometer 111 with respect to mean sea level, and
   H≈7000 meters, and
   p₁ is first measurement of absolute barometric pressure by barometer 111 for moment-in-time t₁.

In contrast, when the indication of whether or not wireless terminal 113-1 was stationary during the time-interval Δt indicates that wireless terminal 113-1 was stationary, then altitude server 131 generates the estimate of p₀ according to:

$${p}_{0} = ( {p}_{1} + Δ p ) {e}^{( \frac{{z}_{b}}{H} )} \qquad ( Eq . 1 b )$$

wherein:
   z_{b} is the estimate of the altitude of primary barometer 111 with respect to mean sea level, and
   H≈7000 meters, and
   p₁ is first measurement of absolute barometric pressure by barometer 111 for moment-in-time t₁, and
Δp is the change in barometric pressure Δp during the time-interval Δt as measured by wireless terminal 113-1.

After altitude server 131 generates the estimate of p₀, altitude server 131 then generates an estimate of the altitude of wireless terminal 113-1, z_{w}, at moment-in-time t₂ based on:

$${z}_{w} = - H ln ( \frac{{p}_{2}}{{p}_{0}} ) \qquad ( Eq . 2 )$$

wherein
   z_{w} is the estimate of the altitude of wireless terminal 113-1 at moment-in-time t₂, and
   H≈7000 meters, and
   p₂ is the second measurement of absolute barometric pressure, and
   p₀ is the estimate of the reference barometric pressure, as just computed in either Equation 1a or 1b.
      It will be clear to those skilled in the art, after reading this disclosure, how to make and use alternative embodiments of the present invention that use different functions than Equation 1a, 1b, or 2. In any case, it will be clear to those skilled in the art, after reading this disclosure, how to make and use alternative embodiments of the present invention that perform task 703.

At task 704, altitude server 131 generates an estimate of the altitude of wireless terminal 113-1, s_{w}, at moment-in-time t₂ as measured in building stories above local ground level. In accordance with the first illustrative embodiment, the estimate is based on:
(i) the estimate of the altitude of wireless terminal 113-1, z_{w}, at moment-in-time t₂ in meters above mean sea level, and
(ii) estimate of the latitude and longitude of wireless terminal 113-1 at the second moment-in-time t₂, and
(iii) topographic map 508 of geographic region 101 which provides an estimate of the altitude of local ground level above mean sea level for the latitude and longitude of wireless terminal 113-1 at the second moment-in-time t₂, and
(iv) a function that converts the estimate of altitude of local ground level above mean sea level into an estimate of building stories above local ground level.
   The details of task 704 are described in detail below and in the accompanying figures. It will be clear to those skilled in the art, after reading this disclosure, how to make and use embodiments of the present invention that perform task 704.

At task 705, altitude server 131 transmits:
(i) the estimate of the altitude of wireless terminal 113-1, z_{w}, in meters above mean sea level, and
(ii) the estimate of the altitude of wireless terminal 113-1, s_{w}, in building stories above local ground level
   to:
(a) wireless terminal 113-1, and
(b) location-based-application server 141.
   It will be clear to those skilled in the art, after reading this disclosure, how to make and use alternative embodiments of the present invention in which altitude server 131 transmits:
(i) the estimate of the altitude of wireless terminal 113-1, z_{w}, in meters above mean sea level, or
(ii) the estimate of the altitude of wireless terminal 113-1, s_{w}, in building stories above local ground level, or
(iii) both (i) and (ii)
   to:
(a) wireless terminal 113-1, or
(b) location-based-application server 141, or
(c) one or more other entities (e.g., wireless terminal 113-2, wireless terminal 113-3, etc.), or
(d) any combination of (a), (b), and (c).
   It will be clear to those skilled in the art, after reading this disclosure, how to make and use embodiments of the present invention that perform task 705.

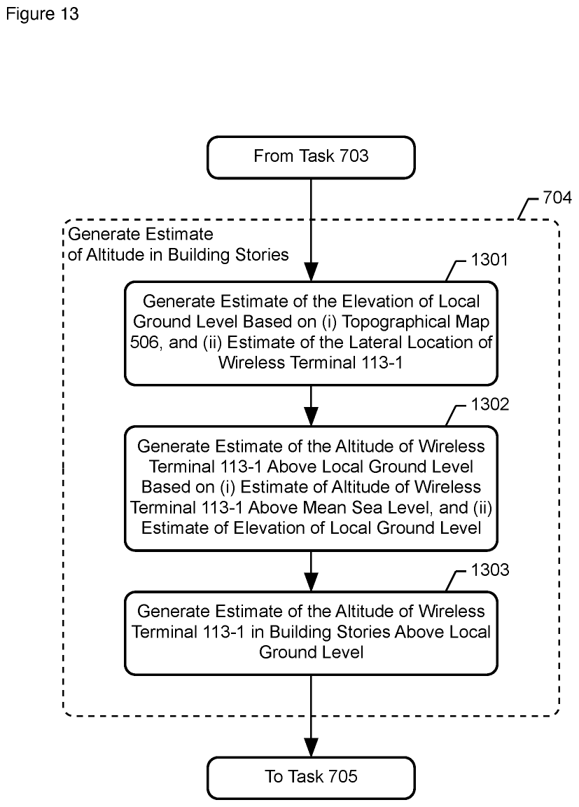

FIG. 13 depicts a flowchart of the operation of the task 704—generates an estimate of the altitude of wireless terminal 113-1, s_{w}, in building stories above local ground level.

At task 1301, altitude server 131 generates an estimate of the elevation of local ground level, e, in meters above mean sea level at the latitude and longitude of wireless terminal 113-1 at the second moment-in-time t₂ based on:
(i) topographic map 506, and
(ii) the estimate of the latitude and longitude of wireless terminal 113-1 at the second moment-in-time t₂.
   It will be clear to those skilled in the art how to make and use embodiments of the present invention that perform task 1301.

At task 1302, altitude server 131 generates an estimate of the altitude of wireless terminal 113-1, a_{w}, in meters above local ground level based on:

$${a}_{w} = {z}_{w} - e \qquad ( Eq . 2 )$$

It will be clear to those skilled in the art how to make and use embodiments of the present invention that perform task 1302.

At task 1303, altitude server 131 generates the estimate of the altitude of wireless terminal 113-1, s_{w}, in building stories above local ground level based on:

$${s}_{w} = ⌊ \frac{( {a}_{w} - 1.5 )}{3} ⌋ + 1 \qquad ( Eq . 3 )$$

It will be clear to those skilled in the art, after reading this disclosure, how to make and use alternative embodiments of the present invention that use a different function—other than Equation 3—to convert the estimate of the altitude of wireless terminal 113-1, a_{w}, in meters above local ground level into the estimate of the altitude of wireless terminal 113-1, s_{w}, in building stories above local ground level. It will be clear to those skilled in the art how to make and use embodiments of the present invention that perform task 1303.

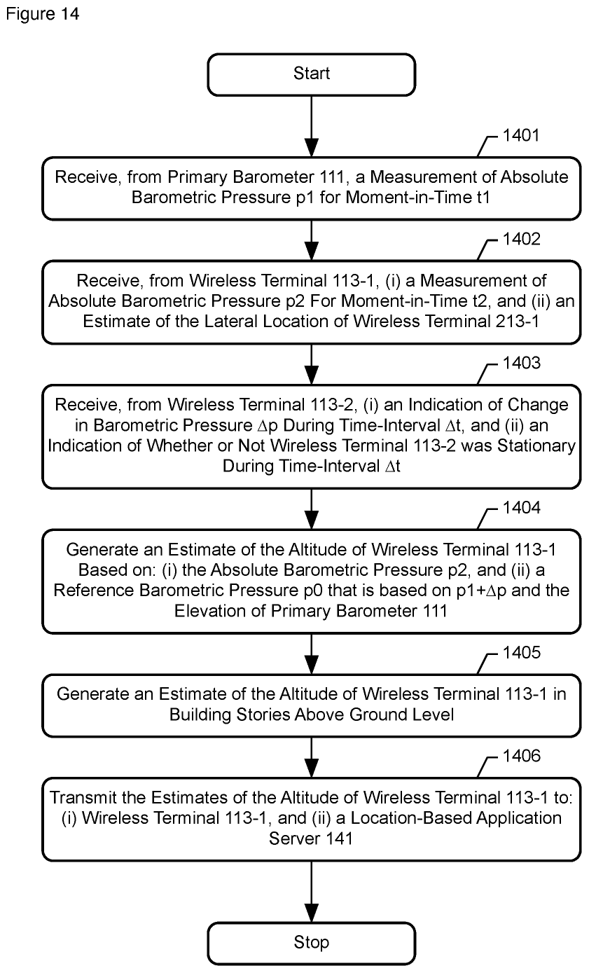

FIG. 14 depicts a flowchart of the operation of the second illustrative embodiment of the present invention.

At task 1401, primary barometer 111 transmits and altitude server 131 receives a first measurement of absolute barometric pressure p₁ for moment-in-time t₁, wherein the first measurement of absolute barometric pressure p₁ is measured by barometer 203 in primary barometer 111. It will be clear to those skilled in the art how to make and use embodiments of the present invention that perform task 1401.

At task 1402, wireless terminal 113-1 transmits and altitude server 131 receives:
(i) a second measurement of absolute barometric pressure p₂ at a second moment-in-time t₂, wherein the second measurement of absolute barometric pressure p₂ is measured by barometer 403 in wireless terminal 113-1, and
(ii) evidence of the latitude and longitude of wireless terminal 113-1 at the second moment-in-time t₂.

In accordance with the second illustrative embodiment, the estimate of the latitude and longitude of wireless terminal 113-1 at moment-of-time t₂ is the latitude and longitude of wireless terminal 113-1. It will be clear to those skilled in the art, after reading this disclosure, how to make and use alternative embodiments of the present invention in which the evidence has another form (e.g., empirical data from which altitude server 131 can infer the latitude and longitude, etc.). In any case, it will be clear to those skilled in the art how to estimate the latitude and longitude of wireless terminal 113-1.

At task 1403, wireless terminal 113-2 transmits and altitude server 131 receives:
(i) an indication of a change in barometric pressure Δp during a time-interval Δt, wherein the change in barometric pressure Δp is measured by barometer 403 in wireless terminal 113-2, and
(ii) an indication of whether or not wireless terminal 113-2 was stationary during the time-interval Δt.

In accordance with the second illustrative embodiment, the first moment-in-time t₁ is before the second moment-in-time t₂. In accordance with the second illustrative embodiment, the time-interval Δt is contemporaneous with the time-interval from the first moment-in-time t₁ to the second moment-in-time t₂, as shown in FIG. 8. In contrast, it will be clear to those skilled in the art, however, after reading this disclosure, how to make and use alternative embodiments of the present invention in which:
(i) the time-interval Δt is not contemporaneous with the time-interval from the first moment-in-time t₁ to the second moment-in-time t₂, and
(ii) the majority of the time-interval Δt overlaps the time-interval from the first moment-in-time t₁ to the second moment-in-time t₂, and
(iii) the majority of the time-interval from the first moment-in-time t₁ to the second moment-in-time t₂ overlaps the time-interval Δt,
   as shown, for example, in FIG. 9.

In accordance with the second illustrative embodiment, wireless terminal 113-2 is that wireless terminal that is closest to wireless terminal 113-1.

In accordance with the second illustrative embodiment, wireless terminal 113-1 estimates whether it was stationary or not during the time-interval Δt based, at least in part, measurements of accelerometer 404 during the time-interval Δt. It will be clear to those skilled in the art, after reading this disclosure, how to make and use alternative embodiments of the present invention in which a wireless terminal estimates whether it is stationary or not during the time-interval Δt based on other sensors and/or criteria.

At task 1404, altitude server 131:
(1) generates an estimate of what the reference barometric pressure p₀ would be at mean sea level at the latitude and longitude of wireless terminal 113-1, and
(2) uses that reference barometric pressure p₀ to generate an estimate of the altitude of wireless terminal 113-1 z_{w} at moment-in-time t₂.

When the indication of whether or not wireless terminal 113-2 was stationary during the time-interval Δt indicates that wireless terminal 113-2 was not stationary, then altitude server 131 generates the estimate of p₀ according to:

$${p}_{0} = {p}_{1} {e}^{( \frac{{z}_{b}}{H} )} \qquad ( Eq . 1 a )$$

wherein:
   z_{b} is the estimate of the altitude of primary barometer 111 with respect to mean sea level, and
   H≈7000 meters, and
   p₁ is first measurement of absolute barometric pressure by barometer 111 for moment-in-time t₁.

In contrast, when the indication of whether or not wireless terminal 113-2 was stationary during the time-interval Δt indicates that wireless terminal 113-2 was stationary, then altitude server 131 generates the estimate of p₀ according to:

$${p}_{0} = ( {p}_{1} + Δ p ) {e}^{( \frac{{z}_{b}}{H} )} \qquad ( Eq . 1 b )$$

wherein:
   z_{b} is the estimate of the altitude of primary barometer 111 with respect to mean sea level, and
   H≈7000 meters, and
   p₁ is first measurement of absolute barometric pressure by barometer 111 for moment-in-time t₁, and
   Δp is the change in barometric pressure Δp during the time-interval Δt as measured by wireless terminal 113-1.

After altitude server 131 generates the estimate of p₀, altitude server 131 then generates an estimate of the altitude of wireless terminal 113-1, z_{w}, at moment-in-time t₂ based on:

$${z}_{w} = - H ln ( \frac{{p}_{2}}{{p}_{0}} ) \qquad ( Eq . 2 )$$

wherein.
   z_{w} is the estimate of the altitude of wireless terminal 113-1 at moment-in-time t₂, and
   H≈7000 meters, and
   p₂ is the second measurement of absolute barometric pressure, and
   p₀ is the estimate of the reference barometric pressure, as just computed in either Equation 1a or 1b.

It will be clear to those skilled in the art, after reading this disclosure, how to make and use alternative embodiments of the present invention that use different functions than Equation 1a, 1b, or 2. In any case, it will be clear to those skilled in the art, after reading this disclosure, how to make and use alternative embodiments of the present invention that perform task 1404.

At task 1405, altitude server 131 generates an estimate of the altitude of wireless terminal 113-1, s_{w}, at moment-in-time t₂ as measured in building stories above local ground level. In accordance with the second illustrative embodiment, the estimate is based on:
(i) the estimate of the altitude of wireless terminal 113-1, z_{w}, at moment-in-time t₂ in meters above mean sea level, and
(ii) estimate of the latitude and longitude of wireless terminal 113-1 at the second moment-in-time t₂, and
(iii) topographic map 508 of geographic region 101 which provides an estimate of the altitude of local ground level above mean sea level for the latitude and longitude of wireless terminal 113-1 at the second moment-in-time t₂, and
(iv) a function that converts the estimate of altitude of local ground level above mean sea level into an estimate of building stories above local ground level.
   Task 1405 is identical to task 704, which is described in detail above and in the accompanying figure.

At task 1406, altitude server 131 transmits:
(i) the estimate of the altitude of wireless terminal 113-1, z_{w}, in meters above mean sea level, and
(ii) the estimate of the altitude of wireless terminal 113-1, s_{w}, in building stories above local ground level
   to:
(a) wireless terminal 113-1, and
(b) location-based-application server 141.
   It will be clear to those skilled in the art, after reading this disclosure, how to make and use alternative embodiments of the present invention in which altitude server 131 transmits:
(i) the estimate of the altitude of wireless terminal 113-1, z_{w}, in meters above mean sea level, or
(ii) the estimate of the altitude of wireless terminal 113-1, s_{w}, in building stories above local ground level, or
(iii) both (i) and (ii)
   to:
(a) wireless terminal 113-1, or
(b) location-based-application server 141, or
(c) one or more other entities (e.g., wireless terminal 113-2, wireless terminal 113-3, etc.), or
(d) any combination of (a), (b), and (c).
   It will be clear to those skilled in the art, after reading this disclosure, how to make and use embodiments of the present invention that perform task 1406.

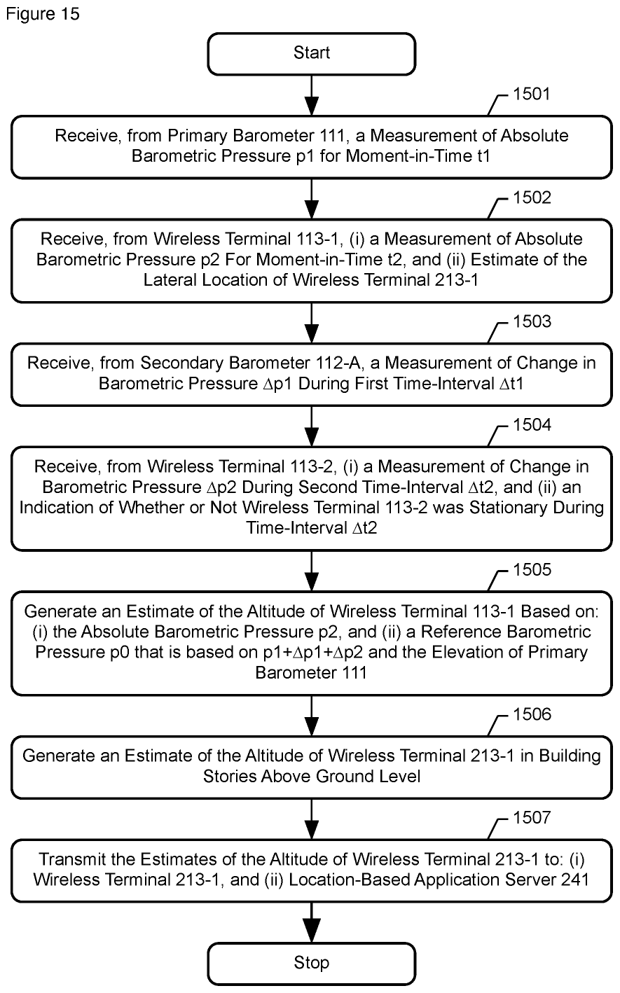

FIG. 15 depicts a flowchart of the operation of the third illustrative embodiment of the present invention.

At task 1501, primary barometer 111 transmits and altitude server 131 receives a first measurement of absolute barometric pressure p₁ for moment-in-time t₁, wherein the first measurement of absolute barometric pressure p₁ is measured by barometer 203 in primary barometer 111. It will be clear to those skilled in the art how to make and use embodiments of the present invention that perform task 1501.

At task 1502, wireless terminal 113-1 transmits and altitude server 131 receives:
(i) a second measurement of absolute barometric pressure p₂ at a second moment-in-time t₂, wherein the second measurement of absolute barometric pressure p₂ is measured by barometer 403 in wireless terminal 113-1, and
(ii) evidence of the latitude and longitude of wireless terminal 113-1 at the second moment-in-time t₂.

In accordance with the third illustrative embodiment, the estimate of the latitude and longitude of wireless terminal 113-1 at moment-of-time t₂ is the latitude and longitude of wireless terminal 113-1. It will be clear to those skilled in the art, after reading this disclosure, how to make and use alternative embodiments of the present invention in which the evidence has another form (e.g., empirical data from which altitude server 131 can infer the latitude and longitude, etc.). In any case, it will be clear to those skilled in the art how to estimate the latitude and longitude of wireless terminal 113-1.

At task 1503, secondary barometer 112-1 transmits and altitude server 131 receives a measurement of a change in barometric pressure Δp₁ during time-interval Δt₁.

At task 1504, wireless terminal 113-2 transmits and altitude server 131 receives:
(i) an indication of a change in barometric pressure Δp₂ during a time-interval Δt₂, wherein the change in barometric pressure Δp₂ is measured by barometer 403 in wireless terminal 113-2, and
(ii) an indication of whether or not wireless terminal 113-2 was stationary during the time-interval Δt₂.

In accordance with the third illustrative embodiment:
(i) the second time-interval Δt₂ succeeds the first time-interval Δt₁, and
(ii) the combination of the first time-interval Δt₁ and the second time-interval Δt₂ is contemporaneous with the time-interval from the first moment-in-time t₁ to the second moment-in-time t₂,
   as shown in FIG. 10. It will be clear to those skilled in the art, however, after reading this disclosure, how to make and use alternative embodiments of the present invention in which:
(i) the first time-interval Δt₁ and the second time-interval Δt₂ are not successive and overlap (as shown, for example and without limitation, in FIG. 11), or
(ii) the first time-interval Δt₁ and the second time-interval Δt₂ are not successive and do not overlap (as shown, for example and without limitation, in FIG. 12), or
(iii) the first time-interval Δt₁ succeeds the second time-interval Δt₂.
   In these cases:
(a) the majority of combination of the first time-interval Δt₁ and the second time-interval Δt₂ overlaps the time-interval from the first moment-in-time t₁ to the second moment-in-time t₂ (as shown, for example, in FIGS. 11 and 12), and
(b) the majority of the time-interval from the first moment-in-time t₁ to the second moment-in-time t₂ overlaps the combination of the first time-interval Δt₁ and the second time-interval Δt₂ (as shown, for example, in FIGS. 11 and 12).

In accordance with the third illustrative embodiment, the evidence that wireless terminal 113-1 was stationary during the time-interval from the second moment-in-time t₂ to the second moment-in-time t₂ is a flag.

At task 1505, altitude server 131:
(1) generates an estimate of what the reference barometric pressure p₀ would be at mean sea level at the latitude and longitude of wireless terminal 113-1, and
(2) uses that reference barometric pressure p₀ to generate an estimate of the altitude of wireless terminal 113-1 z_{w} at moment-in-time t₂.

When the indication of whether or not wireless terminal 113-2 was stationary during the time-interval Δt indicates that wireless terminal 113-2 was not stationary, then altitude server 131 generates the estimate of p₀ according to:

$${p}_{0} = ( {p}_{1} + Δ {p}_{1} ) {e}^{( \frac{{z}_{b}}{H} )} \qquad ( Eq . 1 c )$$

wherein:
   z_{b} is the estimate of the altitude of primary barometer 111 with respect to mean sea level, and
   H≈7000 meters, and
   p₁ is the first measurement of absolute barometric pressure by barometer 111 for moment-in-time t₁, and
   Δp₁ is the measurement of the change in barometric pressure during time-interval Δt₁ at secondary barometer 112-1.

In contrast, when the indication of whether or not wireless terminal 113-2 was stationary during the time-interval Δt indicates that wireless terminal 113-2 was stationary, then altitude server 131 generates the estimate of p₀ according to:

$${p}_{0} = ( {p}_{1} + Δ {p}_{1} + Δ {p}_{2} ) {e}^{( \frac{{z}_{b}}{H} )} \qquad ( Eq . 1 d )$$

wherein:
   z_{b} is the estimate of the altitude of primary barometer 111 with respect to mean sea level, and
   H≈7000 meters, and
   p₁ is first measurement of absolute barometric pressure by barometer 111 for moment-in-time t₁, and
   Δp₁ is the measurement of the change in barometric pressure during time-interval Δt₁ at secondary barometer 112-1, and
   Δp₂ is the measurement of the change in barometric pressure during time-interval Δt₂ at wireless terminal 113-2.

After altitude server 131 generates the estimate of p₀, altitude server 131 then generates an estimate of the altitude of wireless terminal 113-1, z_{w}, at moment-in-time t₂ based on:

$${z}_{w} = - H ln ( \frac{{p}_{2}}{{p}_{0}} ) \qquad ( Eq . 2 )$$

wherein
   z_{w} is the estimate of the altitude of wireless terminal 113-1 at moment-in-time t₂, and
   H≈7000 meters, and
   p₂ is the second measurement of absolute barometric pressure, and
   p₀ is the estimate of the reference barometric pressure, as just computed in either Equation 1c or 1d.
      It will be clear to those skilled in the art, after reading this disclosure, how to make and use alternative embodiments of the present invention that use different functions than Equation 1c, 1d, or 2. In any case, it will be clear to those skilled in the art, after reading this disclosure, how to make and use alternative embodiments of the present invention that perform task 1505

At task 1506, altitude server 131 generates an estimate of the altitude of wireless terminal 113-1, s_{w}, at moment-in-time t₂ as measured in building stories above local ground level. In accordance with the third illustrative embodiment, the estimate is based on:
(i) the estimate of the altitude of wireless terminal 113-1, z_{w}, at moment-in-time t₂ in meters above mean sea level, and
(ii) estimate of the latitude and longitude of wireless terminal 113-1 at the second moment-in-time t₂, and
(iii) topographic map 508 of geographic region 101 which provides an estimate of the altitude of local ground level above mean sea level for the latitude and longitude of wireless terminal 113-1 at the second moment-in-time t₂, and
(iv) a function that converts the estimate of altitude of local ground level above mean sea level into an estimate of building stories above local ground level.
   Task 1506 is identical to task 704, which is described in detail above and in the accompanying figure.

At task 1507, altitude server 131 transmits:
(i) the estimate of the altitude of wireless terminal 113-1, z_{w}, in meters above mean sea level, and
(ii) the estimate of the altitude of wireless terminal 113-1, s_{w}, in building stories above local ground level
   to:
(a) wireless terminal 113-1, and
(b) location-based-application server 141.
   It will be clear to those skilled in the art, after reading this disclosure, how to make and use alternative embodiments of the present invention in which altitude server 131 transmits:
(i) the estimate of the altitude of wireless terminal 113-1, z_{w}, in meters above mean sea level, or
(ii) the estimate of the altitude of wireless terminal 113-1, s_{w}, in building stories above local ground level, or
(iii) both (i) and (ii)
   to:
(a) wireless terminal 113-1, or
(b) location-based-application server 141, or
(c) one or more other entities (e.g., wireless terminal 113-2, wireless terminal 113-3, etc.), or
(d) any combination of (a), (b), and (c).
   It will be clear to those skilled in the art, after reading this disclosure, how to make and use embodiments of the present invention that perform task 1507.

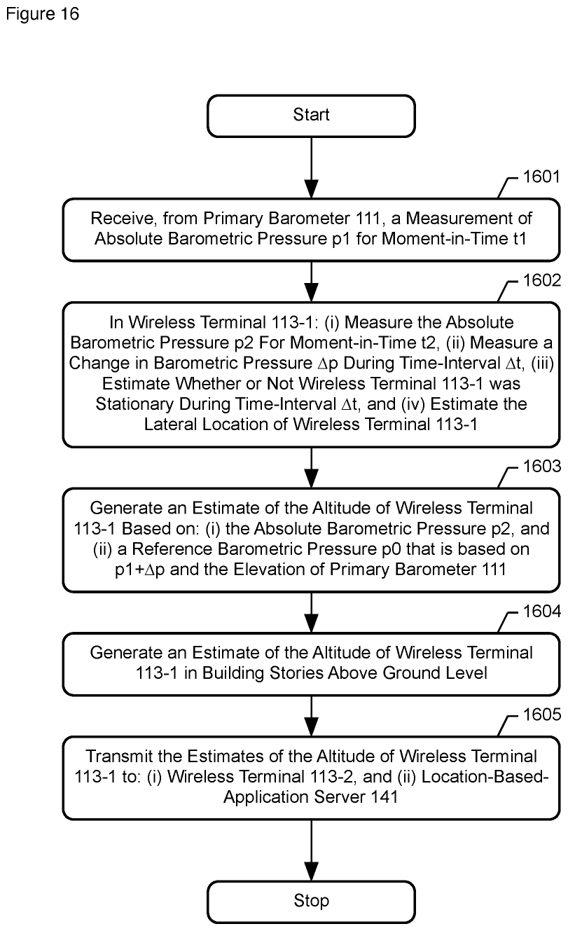

FIG. 16 depicts a flowchart of the operation of the fourth illustrative embodiment of the present invention.

At task 1601, primary barometer 111 transmits and wireless terminal 113-1 receives a first measurement of absolute barometric pressure p₁ for moment-in-time t₁, wherein the first measurement of absolute barometric pressure p₁ is measured by barometer 203 in primary barometer 111. It will be clear to those skilled in the art how to make and use embodiments of the present invention that perform task 1601.

At task 1602, wireless terminal 113-1:
(i) measures a second measurement of absolute barometric pressure p₂ at a second moment-in-time t₂, wherein the second measurement of absolute barometric pressure p₂ is measured by barometer 403 in wireless terminal 113-1, and
(ii) measures a change in barometric pressure Δp during a time-interval Δt, wherein the change in barometric pressure Δp is measured by barometer 403 in wireless terminal 113-1, and
(iii) generates an estimate of whether or not wireless terminal 113-1 was stationary during the time-interval Δt, and
(iv) estimates the latitude and longitude of wireless terminal 113-1 at the second moment-in-time t₂.

In accordance with the first the illustrative embodiment, the first moment-in-time t₁ is before the second moment-in-time t₂. In accordance with the fourth illustrative embodiment, the time-interval Δt is contemporaneous with the time-interval from the first moment-in-time t₁ to the second moment-in-time t₂, as shown in FIG. 8. In contrast, it will be clear to those skilled in the art, however, after reading this disclosure, how to make and use alternative embodiments of the present invention in which:
(i) the time-interval Δt is not contemporaneous with the time-interval from the first moment-in-time t₁ to the second moment-in-time t₂, and
(ii) the majority of the time-interval Δt overlaps the time-interval from the first moment-in-time t₁ to the second moment-in-time t₂, and
(iii) the majority of the time-interval from the first moment-in-time t₁ to the second moment-in-time t₂ overlaps the time-interval Δt,
   as shown, for example, in FIG. 9.

In accordance with the fourth illustrative embodiment, wireless terminal 113-1 estimates whether it was stationary or not during the time-interval Δt based, at least in part, measurements of accelerometer 404 during the time-interval Δt. It will be clear to those skilled in the art, after reading this disclosure, how to make and use alternative embodiments of the present invention in which a wireless terminal estimates whether it is stationary or not during the time-interval Δt based on other sensors and/or criteria.

In accordance with the fourth illustrative embodiment, the evidence of the latitude and longitude of wireless terminal 113-1 at moment-of-time t₂ is the latitude and longitude of wireless terminal 113-1. It will be clear to those skilled in the art, after reading this disclosure, how to make and use alternative embodiments of the present invention in which the evidence has another form (e.g., empirical data from which wireless terminal 113-1 can infer the latitude and longitude, etc.). In any case, it will be clear to those skilled in the art how to provide evidence of the latitude and longitude of wireless terminal 113-1.

At task 1603, wireless terminal 113-1:
(1) generates an estimate of what the reference barometric pressure p₀ would be at mean sea level at the latitude and longitude of wireless terminal 113-1, and
(2) uses that reference barometric pressure p₀ to generate an estimate of the altitude of wireless terminal 113-1 z_{w} at moment-in-time t₂.

When the indication of whether or not wireless terminal 113-1 was stationary during the time-interval Δt indicates that wireless terminal 113-1 was not stationary, then wireless terminal 113-1 generates the estimate of p₀ according to:

$${p}_{0} = {p}_{1} {e}^{( \frac{{z}_{b}}{H} )} \qquad ( Eq . 1 a )$$

wherein:
   z_{b} is the estimate of the altitude of primary barometer 111 with respect to mean sea level, and
   H≈7000 meters, and
   p₁ is first measurement of absolute barometric pressure by barometer 111 for moment-in-time t₁.

In contrast, when the indication of whether or not wireless terminal 113-1 was stationary during the time-interval Δt indicates that wireless terminal 113-1 was stationary, then wireless terminal 113-1 generates the estimate of p₀ according to:

$${p}_{0} = ( {p}_{1} + Δ p ) {e}^{( \frac{{z}_{b}}{H} )} \qquad ( Eq . 1 b )$$

wherein:
   z_{b} is the estimate of the altitude of primary barometer 111 with respect to mean sea level, and
   H≈7000 meters, and
   p₁ is first measurement of absolute barometric pressure by barometer 111 for moment-in-time t₁, and
   Δp is the change in barometric pressure Δp during the time-interval Δt as measured by wireless terminal 113-1.

After wireless terminal 113-1 generates the estimate of p₀, wireless terminal 113-1 then generates an estimate of the altitude of wireless terminal 113-1, z_{w}, at moment-in-time t₂ based on:

$${z}_{w} = - H ln ( \frac{{p}_{2}}{{p}_{0}} ) \qquad ( Eq . 2 )$$

wherein
   z_{w} is the estimate of the altitude of wireless terminal 113-1 at moment-in-time t₂, and
   H≈7000 meters, and
   p₂ is the second measurement of absolute barometric pressure, and
   p₀ is the estimate of the reference barometric pressure, as just computed in either Equation 1a or 1b.
      It will be clear to those skilled in the art, after reading this disclosure, how to make and use alternative embodiments of the present invention that use different functions than Equation 1a, 1b, or 2. In any case, it will be clear to those skilled in the art, after reading this disclosure, how to make and use alternative embodiments of the present invention that perform task 1603.

At task 1604, wireless terminal 113-1 generates an estimate of the altitude of wireless terminal 113-1, s_{w}, at moment-in-time t₂ as measured in building stories above local ground level. In accordance with the fourth illustrative embodiment, the estimate is based on:
(i) the estimate of the altitude of wireless terminal 113-1, z_{w}, at moment-in-time t₂ in meters above mean sea level, and
(ii) estimate of the latitude and longitude of wireless terminal 113-1 at the second moment-in-time t₂, and
(iii) topographic map 508 of geographic region 101 which provides an estimate of the altitude of local ground level above mean sea level for the latitude and longitude of wireless terminal 113-1 at the second moment-in-time t₂, and
(iv) a function that converts the estimate of altitude of local ground level above mean sea level into an estimate of building stories above local ground level.
   Task 1604 is identical to task 704, which is described in detail above and in the accompanying figure.

At task 1605, wireless terminal 113-1 transmits:
(i) the estimate of the altitude of wireless terminal 113-1, z_{w}, in meters above mean sea level, and
(ii) the estimate of the altitude of wireless terminal 113-1, s_{w}, in building stories above local ground level
   to location-based-application server 141. It will be clear to those skilled in the art, after reading this disclosure, how to make and use alternative embodiments of the present invention in which wireless terminal 113-1 transmits:
(i) the estimate of the altitude of wireless terminal 113-1, z_{w}, in meters above mean sea level, or
(ii) the estimate of the altitude of wireless terminal 113-1, s_{w}, in building stories above local ground level, or
(iii) both (i) and (ii)
   to:
(a) location-based-application server 141, or
(b) one or more other entities (e.g., wireless terminal 113-2, wireless terminal 113-3, etc.), or
(c) any combination of (a) and (b).
   It will be clear to those skilled in the art, after reading this disclosure, how to make and use embodiments of the present invention that perform task 1605.

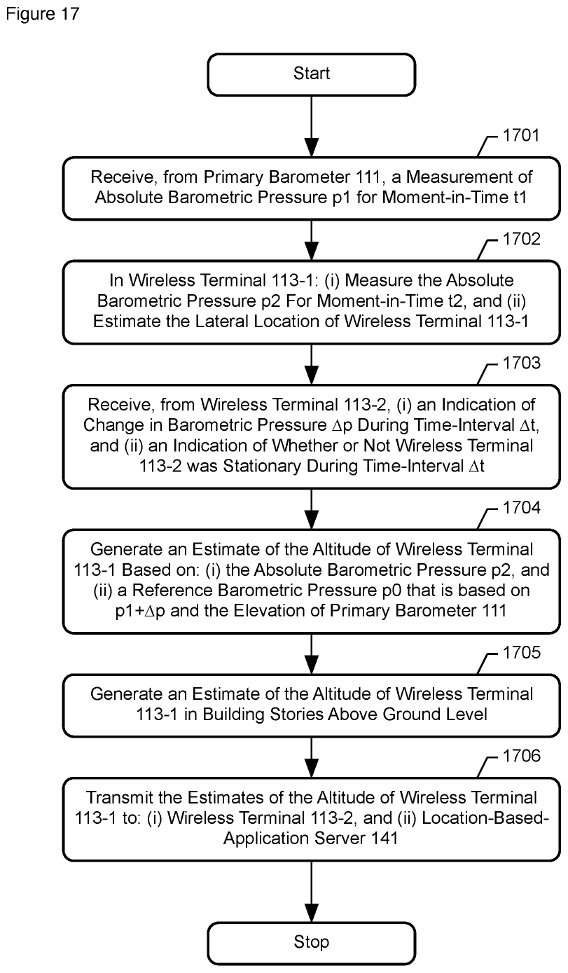

FIG. 17 depicts a flowchart of the operation of the fifth illustrative embodiment of the present invention.

At task 1701, primary barometer 111 transmits and wireless terminal 113-1 receives a first measurement of absolute barometric pressure p₁ for moment-in-time t₁, wherein the first measurement of absolute barometric pressure p₁ is measured by barometer 203 in primary barometer 111. It will be clear to those skilled in the art how to make and use embodiments of the present invention that perform task 1701.

At task 1702, wireless terminal 113-1:
(i) measures a second measurement of absolute barometric pressure p₂ at a second moment-in-time t₂, wherein the second measurement of absolute barometric pressure p₂ is measured by barometer 403 in wireless terminal 113-1, and
(ii) estimates the latitude and longitude of wireless terminal 113-1 at the second moment-in-time t₂.

In accordance with the fifth illustrative embodiment, the estimate of the latitude and longitude of wireless terminal 113-1 at moment-of-time t₂ is the latitude and longitude of wireless terminal 113-1. It will be clear to those skilled in the art, after reading this disclosure, how to make and use alternative embodiments of the present invention in which the evidence has another form (e.g., empirical data from which wireless terminal 113-1 can infer the latitude and longitude, etc.). In any case, it will be clear to those skilled in the art how to estimate the latitude and longitude of wireless terminal 113-1.

At task 1703, wireless terminal 113-2 transmits and wireless terminal 113-1 receives:
(i) an indication of a change in barometric pressure Δp during a time-interval Δt, wherein the change in barometric pressure Δp is measured by barometer 403 in wireless terminal 113-2, and
(ii) an indication of whether or not wireless terminal 113-2 was stationary during the time-interval Δt.

In accordance with the fifth illustrative embodiment, the first moment-in-time t₁ is before the second moment-in-time t₂. In accordance with the fifth illustrative embodiment, the time-interval Δt is contemporaneous with the time-interval from the first moment-in-time t₁ to the second moment-in-time t₂, as shown in FIG. 8. In contrast, it will be clear to those skilled in the art, however, after reading this disclosure, how to make and use alternative embodiments of the present invention in which:
(i) the time-interval Δt is not contemporaneous with the time-interval from the first moment-in-time t₁ to the second moment-in-time t₂, and
(ii) the majority of the time-interval Δt overlaps the time-interval from the first moment-in-time t₁ to the second moment-in-time t₂, and
(iii) the majority of the time-interval from the first moment-in-time t₁ to the second moment-in-time t₂ overlaps the time-interval Δt,
   as shown, for example, in FIG. 9.

In accordance with the fifth illustrative embodiment, wireless terminal 113-2 is that wireless terminal that is closest to wireless terminal 113-1.

In accordance with the fifth illustrative embodiment, wireless terminal 113-1 estimates whether it was stationary or not during the time-interval Δt based, at least in part, measurements of accelerometer 404 during the time-interval Δt. It will be clear to those skilled in the art, after reading this disclosure, how to make and use alternative embodiments of the present invention in which a wireless terminal estimates whether it is stationary or not during the time-interval Δt based on other sensors and/or criteria.

At task 1704, wireless terminal 113-1:
(1) generates an estimate of what the reference barometric pressure p₀ would be at mean sea level at the latitude and longitude of wireless terminal 113-1, and
(2) uses that reference barometric pressure p₀ to generate an estimate of the altitude of wireless terminal 113-1 z_{w} at moment-in-time t₂.

When the indication of whether or not wireless terminal 113-2 was stationary during the time-interval Δt indicates that wireless terminal 113-2 was not stationary, then wireless terminal 113-1 generates the estimate of p₀ according to:

$${p}_{0} = {p}_{1} {e}^{( \frac{{z}_{b}}{H} )} \qquad ( Eq . 1 a )$$

wherein:
   z_{b} is the estimate of the altitude of primary barometer 111 with respect to mean sea level, and
   H≈7000 meters, and
   p₁ is first measurement of absolute barometric pressure by barometer 111 for moment-in-time t₁.

In contrast, when the indication of whether or not wireless terminal 113-2 was stationary during the time-interval Δt indicates that wireless terminal 113-2 was stationary, then wireless terminal 113-1 generates the estimate of p₀ according to:

$${p}_{0} = ( {p}_{1} + Δ p ) {e}^{( \frac{{z}_{b}}{H} )} \qquad ( Eq . 1 b )$$

wherein:
   z_{b} is the estimate of the altitude of primary barometer 111 with respect to mean sea level, and
   H≈7000 meters, and
   p₁ is first measurement of absolute barometric pressure by barometer 111 for moment-in-time t₁, and
   Δp is the change in barometric pressure Δp during the time-interval Δt as measured by wireless terminal 113-1.

After wireless terminal 113-1 generates the estimate of p₀, wireless terminal 113-1 then generates an estimate of the altitude of wireless terminal 113-1, z_{w}, at moment-in-time t₂ based on:

$${z}_{w} = - H ln ( \frac{{p}_{2}}{{p}_{0}} ) \qquad ( Eq . 2 )$$

wherein.
   z_{w} is the estimate of the altitude of wireless terminal 113-1 at moment-in-time t₂, and
   H≈7000 meters, and
   p₂ is the second measurement of absolute barometric pressure, and
   p₀ is the estimate of the reference barometric pressure, as just computed in either Equation 1a or 1b.
      It will be clear to those skilled in the art, after reading this disclosure, how to make and use alternative embodiments of the present invention that use different functions than Equation 1a, 1b, or 2. In any case, it will be clear to those skilled in the art, after reading this disclosure, how to make and use alternative embodiments of the present invention that perform task 1704.

At task 1705, wireless terminal 113-1 generates an estimate of the altitude of wireless terminal 113-1, s_{w}, at moment-in-time t₂ as measured in building stories above local ground level. In accordance with the fifth illustrative embodiment, the estimate is based on:
(i) the estimate of the altitude of wireless terminal 113-1, z_{w}, at moment-in-time t₂ in meters above mean sea level, and
(ii) estimate of the latitude and longitude of wireless terminal 113-1 at the second moment-in-time t₂, and
(iii) topographic map 508 of geographic region 101 which provides an estimate of the altitude of local ground level above mean sea level for the latitude and longitude of wireless terminal 113-1 at the second moment-in-time t₂, and
(iv) a function that converts the estimate of altitude of local ground level above mean sea level into an estimate of building stories above local ground level.
   Task 1705 is identical to task 704, which is described in detail above and in the accompanying figure.

At task 1706, wireless terminal 113-1 transmits:
(i) the estimate of the altitude of wireless terminal 113-1, z_{w}, in meters above mean sea level, and
(ii) the estimate of the altitude of wireless terminal 113-1, s_{w}, in building stories above local ground level
   to location-based-application server 141. It will be clear to those skilled in the art, after reading this disclosure, how to make and use alternative embodiments of the present invention in which wireless terminal 113-1 transmits:
(i) the estimate of the altitude of wireless terminal 113-1, z_{w}, in meters above mean sea level, or
(ii) the estimate of the altitude of wireless terminal 113-1, s_{w}, in building stories above local ground level, or
(iii) both (i) and (ii)
   to:
(a) location-based-application server 141, or
(b) one or more other entities (e.g., wireless terminal 113-2, wireless terminal 113-3, etc.), or
(c) any combination of (a) and (b).

It will be clear to those skilled in the art, after reading this disclosure, how to make and use embodiments of the present invention that perform task 1706.

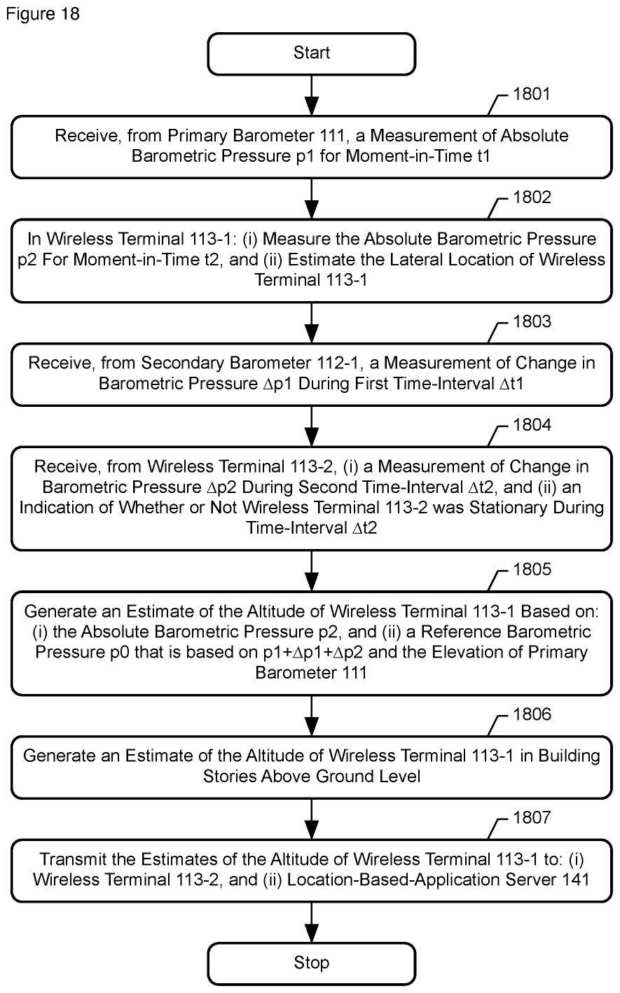

FIG. 18 depicts a flowchart of the operation of the sixth illustrative embodiment of the present invention.

At task 1801, primary barometer 111 transmits and wireless terminal 113-1 receives a first measurement of absolute barometric pressure p₁ for moment-in-time t₁, wherein the first measurement of absolute barometric pressure p₁ is measured by barometer 203 in primary barometer 111. It will be clear to those skilled in the art how to make and use embodiments of the present invention that perform task 1801.

At task 1802, wireless terminal 113-1:
(i) measures a second measurement of absolute barometric pressure p₂ at a second moment-in-time t₂, wherein the second measurement of absolute barometric pressure p₂ is measured by barometer 403 in wireless terminal 113-1, and
(ii) estimates the latitude and longitude of wireless terminal 113-1 at the second moment-in-time t₂.

In accordance with the sixth illustrative embodiment, the estimate of the latitude and longitude of wireless terminal 113-1 at moment-of-time t₂ is the latitude and longitude of wireless terminal 113-1. It will be clear to those skilled in the art, after reading this disclosure, how to make and use alternative embodiments of the present invention in which the evidence has another form (e.g., empirical data from which wireless terminal 113-1 can infer the latitude and longitude, etc.). In any case, it will be clear to those skilled in the art how to estimate the latitude and longitude of wireless terminal 113-1.

At task 1803, secondary barometer 112-1 transmits and wireless terminal 113-1 receives a measurement of a change in barometric pressure Δp₁ during time-interval Δt₁.

At task 1804, wireless terminal 113-2 transmits and wireless terminal 113-1 receives:
(i) an indication of a change in barometric pressure Δp₂ during a time-interval Δt₂, wherein the change in barometric pressure Δp₂ is measured by barometer 403 in wireless terminal 113-2, and
(ii) an indication of whether or not wireless terminal 113-2 was stationary during the time-interval Δt₂.

In accordance with the sixth illustrative embodiment:
(i) the second time-interval Δt₂ succeeds the first time-interval Δt₁, and
(ii) the combination of the first time-interval Δt₁ and the second time-interval Δt₂ is contemporaneous with the time-interval from the first moment-in-time t₁ to the second moment-in-time t₂,
   as shown in FIG. 10. It will be clear to those skilled in the art, however, after reading this disclosure, how to make and use alternative embodiments of the present invention in which:
(i) the first time-interval Δt₁ and the second time-interval Δt₂ are not successive and overlap (as shown, for example and without limitation, in FIG. 11), or
(ii) the first time-interval Δt₁ and the second time-interval Δt₂ are not successive and do not overlap (as shown, for example and without limitation, in FIG. 12), or
(iii) the first time-interval Δt₁ succeeds the second time-interval Δt₂.
   In these cases:
(a) the majority of combination of the first time-interval Δt₁ and the second time-interval Δt₂ overlaps the time-interval from the first moment-in-time t₁ to the second moment-in-time t₂ (as shown, for example, in FIGS. 11 and 12), and
(b) the majority of the time-interval from the first moment-in-time t₁ to the second moment-in-time t₂ overlaps the combination of the first time-interval Δt₁ and the second time-interval Δt₂ (as shown, for example, in FIGS. 11 and 12).

In accordance with the sixth illustrative embodiment, the evidence that wireless terminal 113-1 was stationary during the time-interval from the second moment-in-time t₂ to the second moment-in-time t₂ is a flag.

At task 1805, wireless terminal 113-1:
(1) generates an estimate of what the reference barometric pressure p₀ would be at mean sea level at the latitude and longitude of wireless terminal 113-1, and
(2) uses that reference barometric pressure p₀ to generate an estimate of the altitude of wireless terminal 113-1 z_{w} at moment-in-time t₂.

When the indication of whether or not wireless terminal 113-2 was stationary during the time-interval Δt indicates that wireless terminal 113-2 was not stationary, then wireless terminal 113-1 generates the estimate of p₀ according to:

$${p}_{0} = ( {p}_{1} + Δ {p}_{1} ) {e}^{( \frac{{z}_{b}}{H} )} \qquad ( Eq . 1 c )$$

wherein:
   z_{b} is the estimate of the altitude of primary barometer 111 with respect to mean sea level, and
   H≈7000 meters, and
   p₁ is the first measurement of absolute barometric pressure by barometer 111 for moment-in-time t₁, and
   Δp₁ is the measurement of the change in barometric pressure during time-interval Δt₁ at secondary barometer 112-1.

In contrast, when the indication of whether or not wireless terminal 113-2 was stationary during the time-interval Δt indicates that wireless terminal 113-2 was stationary, then wireless terminal 113-1 generates the estimate of p₀ according to:

$${p}_{0} = ( {p}_{1} + Δ {p}_{1} + Δ {p}_{2} ) {e}^{( \frac{{z}_{b}}{H} )} \qquad ( Eq . 1 d )$$

wherein:
   z_{b} is the estimate of the altitude of primary barometer 111 with respect to mean sea level, and
   H≈7000 meters, and
   p₁ is first measurement of absolute barometric pressure by barometer 111 for moment-in-time t₁, and
   Δp₁ is the measurement of the change in barometric pressure during time-interval Δt₁ at secondary barometer 112-1, and
   Δp₂ is the measurement of the change in barometric pressure during time-interval Δt₂ at wireless terminal 113-2.

After wireless terminal 113-1 generates the estimate of p₀, wireless terminal 113-1 then generates an estimate of the altitude of wireless terminal 113-1, z_{w}, at moment-in-time t₂ based on:

$${z}_{w} = - H ln ( \frac{{p}_{2}}{{p}_{0}} ) \qquad ( Eq . 2 )$$

wherein.
   z_{w} is the estimate of the altitude of wireless terminal 113-1 at moment-in-time t₂, and
   H≈7000 meters, and
   p₂ is the second measurement of absolute barometric pressure, and
   p₀ is the estimate of the reference barometric pressure, as just computed in either Equation 1c or 1d.

It will be clear to those skilled in the art, after reading this disclosure, how to make and use alternative embodiments of the present invention that use different functions than Equation 1a, 1b, or 2. In any case, it will be clear to those skilled in the art, after reading this disclosure, how to make and use alternative embodiments of the present invention that perform task 1805

At task 1806, wireless terminal 113-1 generates an estimate of the altitude of wireless terminal 113-1, s_{w}, at moment-in-time t₂ as measured in building stories above local ground level. In accordance with the sixth illustrative embodiment, the estimate is based on:
(i) the estimate of the altitude of wireless terminal 113-1, z_{w}, at moment-in-time t₂ in meters above mean sea level, and
(ii) estimate of the latitude and longitude of wireless terminal 113-1 at the second moment-in-time t₂, and
(iii) topographic map 508 of geographic region 101 which provides an estimate of the altitude of local ground level above mean sea level for the latitude and longitude of wireless terminal 113-1 at the second moment-in-time t₂, and
(iv) a function that converts the estimate of altitude of local ground level above mean sea level into an estimate of building stories above local ground level.
   Task 1806 is identical to task 704, which is described in detail above and in the accompanying figure.

At task 1807, wireless terminal 113-1 transmits:
(i) the estimate of the altitude of wireless terminal 113-1, z_{w}, in meters above mean sea level, and
(ii) the estimate of the altitude of wireless terminal 113-1, s_{w}, in building stories above local ground level
   to location-based-application server 141. It will be clear to those skilled in the art, after reading this disclosure, how to make and use alternative embodiments of the present invention in which wireless terminal 113-1 transmits:
(i) the estimate of the altitude of wireless terminal 113-1, z_{w}, in meters above mean sea level, or
(ii) the estimate of the altitude of wireless terminal 113-1, s_{w}, in building stories above local ground level, or
(iii) both (i) and (ii)
   to:
(a) location-based-application server 141, or
(b) one or more other entities (e.g., wireless terminal 113-2, wireless terminal 113-3, etc.), or
(c) any combination of (a) and (b).

It will be clear to those skilled in the art, after reading this disclosure, how to make and use embodiments of the present invention that perform task 1807.

What is claimed is:

1. A method comprising:
receiving, from a first barometer, a first measurement of absolute barometric pressure p₁ for a first moment-in-time t₁;
measuring, with a second barometer in a wireless terminal:
(i) a second measurement of absolute barometric pressure p₂ for a second moment-in-time t₂, and
(ii) a change in barometric pressure Δp during a time-interval Δt;
generating, with an accelerometer in the wireless terminal, an estimate of whether or not the wireless terminal was stationary during the time-interval Δt;
when the estimate of whether or not the wireless terminal was stationary during the time-interval Δt indicates that the wireless terminal was indeed stationary, generating, with a processor in the wireless terminal, an estimate of the altitude of the wireless terminal based on:
(i) the second measurement of absolute barometric pressure p₂, and
(ii) a reference barometric pressure p₀ that is based on: (1) the sum of p₁+Δp, and (2) an estimate of the altitude of the first barometer; and
transmitting, to a location-based-application server, the estimate of the altitude of the wireless terminal.

2. The method of claim 1 wherein the estimate of the altitude of the wireless terminal is expressed in building floors above local ground level.

3. The method of claim 1 wherein the estimate of the altitude of the wireless terminal is expressed in meters above mean sea level.

4. The method of claim 1 wherein the time-interval Δt is concurrent with the time-interval from t₁ to t₂.

5. The method of claim 1 wherein:
(i) the time-interval Δt overlaps the majority of the time-interval from t₁ to t₂, and
(ii) the time-interval from t₁ to t₂ overlaps the majority of the time-interval Δt.

6. A method comprising:
receiving, from a first barometer, a first measurement of absolute barometric pressure p₁ for a first moment-in-time t₁;
measuring, with second barometer in a first wireless terminal, a second measurement of absolute barometric pressure p₂ for a second moment-in-time t₂;
receiving, from a second wireless terminal:
(i) an indication of a change in barometric pressure Δp at a third barometer in the second wireless terminal during a time-interval Δt, and
(ii) an indication of whether or not the second wireless terminal was stationary during the time-interval Δt;
when the indication of whether or not the second wireless terminal was stationary during the time-interval Δt indicates that the second wireless terminal was indeed stationary, generating an estimate of the altitude of the first wireless terminal at the second moment-in-time t₂, based on:
(i) the second measurement of absolute barometric pressure p₂, and
(ii) a reference barometric pressure p₀ that is based on: (1) the sum of p₁+Δp, and (2) an estimate of the altitude of the first barometer; and
transmitting, to a location-based-application server, the estimate of the altitude of the first wireless terminal.

7. The method of claim 6 wherein the estimate of the altitude of the first wireless terminal is expressed in building floors above local ground level.

8. The method of claim 6 wherein the estimate of the altitude of the first wireless terminal is expressed in meters above mean sea level.

9. The method of claim 6 wherein the time-interval Δt is concurrent with the time-interval from t₁ to t₂.

10. The method of claim 6 wherein:
(i) the time-interval Δt overlaps the majority of the time-interval from t₁ to t₂, and
(ii) the time-interval from t₁ to t₂ overlaps the majority of the time-interval Δt.

11. The method of claim 6 wherein the indication of a change in barometric pressure barometric pressure Δp is provided by the wireless terminal explicitly.

12. The method of claim 6 wherein the time-interval Δt extends from a third moment-in-time t₃ to a fourth moment-in-time t₄;
wherein the indication of a change in barometric pressure barometric pressure Δp is provided by the second wireless terminal as:
(i) a third measurement of absolute barometric pressure p₃ for the third moment-in-time t₃, and
(ii) a fourth measurement of absolute barometric pressure p₄ for the fourth moment-in-time t₄; and
further comprising determining the change in barometric pressure Δp at the second barometer in the wireless terminal during the time-interval Δt based on the difference of p₄ minus p₃.

13. A method comprising:
receiving, from a first barometer, a first measurement of absolute barometric pressure p₁ for a first moment-in-time t₁;
measuring, with a second barometer in a first wireless terminal, a second measurement of absolute barometric pressure p₂ for a second moment-in-time t₂;
receiving, from a third barometer, an indication of a change in barometric pressure Δp₁ at the third barometer during a first time-interval Δt₁;
receiving, from a second wireless terminal:
(i) an indication of a change in barometric pressure Δp₂ at a fourth barometer in a second wireless terminal during a second time-interval Δt₂;
(ii) an indication of whether or not the second wireless terminal was stationary during the time-interval Δt₂;
when the indication of whether or not the second wireless terminal was stationary during the time-interval Δt indicates that the second wireless terminal was indeed stationary, generating an estimate of the altitude of the first wireless terminal based on:
(i) the second measurement of absolute barometric pressure p₂, and
(ii) a reference barometric pressure p₀ that is based on: (1) the sum of p₁+Δp₁+Δp₂, and (2) an estimate of the altitude of the first barometer; and
transmitting, to a location-based-application server, the estimate of the altitude of the first wireless terminal.

14. The method of claim 11 wherein the estimate of the altitude of the first wireless terminal is expressed in building floors above local ground level.

15. The method of claim 11 wherein the estimate of the altitude of the first wireless terminal is expressed in meters above mean sea level.

16. The method of claim 11 wherein the first time-interval Δt₁ together with the second time-interval Δt₂ are concurrent with the time-interval from t₁ to t₂.

17. The method of claim 11 wherein the first time-interval Δt₁ and the second time-interval Δt₂ together overlap a majority of the time-interval from t₁ to t₂; and
wherein the time-interval from t₁ to t₂ overlaps a majority of the first time-interval Δt₁ and the second time-interval Δt₂ together.

18. The method of claim 11 wherein the indication of a change in barometric pressure barometric pressure Δp₁ is provided by the third barometer explicitly.

19. The method of claim 11 wherein the time-interval Δt₁ extends from a third moment-in-time t₃ to a fourth moment-in-time t₄;
wherein the indication of a change in barometric pressure barometric pressure Δp₁ is provided by the third barometer as:
(i) a third measurement of absolute barometric pressure p₃ for the third moment-in-time t₃, and
(ii) a fourth measurement of absolute barometric pressure p₄ for the fourth moment-in-time t₄; and
further comprising determining the change in barometric pressure Δp at the second barometer in the wireless terminal during the time-interval Δt based on the difference of p₄ minus p₃.
